(19) United States
(12) Patent Application Publication
(10) Pub. No.: US 2005/0103212 A1
(43) Pub. Date: May 19, 2005

(54) Apparatus and method for presenting, serving and protecting food and beverages

(75) Inventors: David V. Cronin, Peabdy, MA (US); Francis J. Caufield, Lexington, MA (US)

Correspondence Address: OSTROLENK FABER GERB & SOFFEN, 1180 AVENUE OF THE AMERICAS, NEW YORK, NY, 100368403, US

(73) Assignee: Eastern Tabletop Manufacturing Company, Inc.

(21) Appl. No.: 10/972,861

(22) Filed: Oct. 25, 2004

Related U.S. Application Data
(60) Provisional application No. 60/519,848, filed on Nov. 13, 2003.
(60) Provisional application No. 60/547,654, filed on Feb. 25, 2004.

(51) Int. Cl. A01J 11/04

(52) U.S. Cl. 99/467

(57) ABSTRACT

Portable tray apparatus and methods for displaying, serving, and conserving food products are provided. The apparatus comprises food support arrangements for making food readily accessible and visible to a person, and for conserving its state of preparation and keeping it free of insects and other airborne sources of food contaminants. The various embodiments include a means for directing a circulating stream of thermally controlled air over the food. Additionally provided are apparatus having catalytic heaters by which gas fuels can be converted to radiant heat for maintaining food at desired temperatures.

### CROSS REFERENCE TO RELATED APPLICATIONS

This application claims the priority and benefit of U.S. Provisional Application Ser. No. 60/519,848, filed Nov. 13, 2003 entitled APPARATUS AND METHOD FOR PRESENTING, SERVING, AND PROTECTING FOOD AND BEVERAGES and U.S. Provisional Application Ser. No. 60/547,654 filed Feb. 25, 2004 entitled APPARATUS AND METHOD FOR PRESENTING, SERVING, AND PROTECTING FOOD AND BEVERAGES, the entire disclosures of each of which are incorporated by reference herein.

### FIELD OF THE INVENTION

This invention, in general, relates to apparatus and methods for use in serving food products and, in particular, to portable apparatus and methods for use in the catering industry and home for presenting and serving food products while conserving their state of preparation.

### BACKGROUND OF THE INVENTION

In the catering industry and households, food products are commonly prepared in location distant from where they are ultimately served. In catering, food preparation takes place at a caterer's base facility and then is transported in a more or less controlled environment to the locations where it is served. Likewise, in the home environment, preparation takes place in the kitchen and then the food is transported elsewhere, such as an outside picnic area, patio, or backyard. In either instance, it is important for health reasons to conserve the initial state of preparation of food and keep it free from environmental contaminants, insects, and other airborne sources of potential food degradation.

It is common practice, in a supermarket environment, for food to be displayed in an open chest with refrigeration both underneath and, by virtue of a refrigerated air curtain, above the presentation. Large stationary machinery, refrigerants and fans are typically involved.

No such complete protection is typically available in the household, picnic area, etc. referred to above. Typically, food stuffs offered in such environments are protected only, at best, by an ice bed below the trays, dishes, etc., on which they are offered.

The problem with cold food is that cooler air naturally migrates downward, away from the trays, dishes, etc. providing no cooling to the top, exposed surfaces of the food stuffs. Further, without cover, those surfaces are subject to invasion by insects and debris. Similarly, uncovered hot foods are also subject to invasion by pathogens.

Consequently, it is a primary object of the present invention to provide portable apparatus and methods by which the initial state of preparation of food products may be conserved while the food products are served at a location distant from their preparation while also operating to protect the food products from airborne contaminants and insects.

Another aspect of this invention deals with the problem of keeping food hot for some period of time during which it is presented and served. For storing and presenting hot food, it is typical to use a chafing dish system heated from underneath by a heat source such as an open-flame receptacle of Sterno® or a specially configured electric resistance heater. In either case, it is desirable that the heat source provides a substantially uninterrupted supply for at least several hours at a time. Because such apparatus is often meant to be mobile and used for presentation in special venues, such as catered outdoor events, requiring a sufficient electric source to be available for heating purposes is inconvenient and undesirable. Moreover, exposed open flames pose safety hazards in addition to violating ordinances in many locales. Consequently, it is another principal object of the present invention to provide a convenient non-electric and non-flame producing heat source for storing and presenting hot food.

### SUMMARY OF THE INVENTION

Portable tray apparatus and methods for displaying, serving, and conserving food products are provided. The apparatus broadly comprises means for supporting food so that is readily accessible and visible to a person and means for directing a circulating stream of thermally controlled air over the food to aid in conserving its state of preparation and keeping it free of insects and other airborne sources of food contaminants.

In one aspect of the invention, one or more electrically powered fans are provided for moving normally downwardly migrating cold air up and over the top of food to form a protecting air curtain. A fan, tangential squirrel-cage in one embodiment or a centrifugal squirrel-cage in another, is instrumental in moving the cold air up and over the foodstuffs. Alternatively, a series of “muffin” or tube axial fans may be employed.

For convenience, in the casual environments of home entertainment and service, these presentation food trays' fans are battery powered, typically 12 VDC in the form of 8 D cells, contained in two tubular housings of 4 cells each, which housings double as the tray's support legs. Typical battery life is 3 hours. Clear alternatives are: Rechargeable batteries, an AC converter and a vehicle (12 VDC) plug-in. For use in bright light conditions, a solar-powered version is shown. Also for use in bright light conditions, a shading device is shown.

Refrigerants are: ice, contained ice, contained eutectic salt packs, refreezable packs in a preferred configuration (with cold-transfer fins described hereinafter) and any of the picnic-cooler type cold packs.

Refrigeration and heating by means of a thermoelectric device are also shown. This version is not to be battery or solar powered because of the thermodynamic issues. AC converter or vehicle power is required.

In another aspect of the invention, a gas fueled catalytic heater is provided as a heating source for storage of hot food. The catalytic heater can generate sufficient heat for maintaining hot food without requiring an electrical supply and without producing a flame. The heater comes in various embodiments that are conveniently adapted for commonly available serving chafing dish systems. In several embodiments, the housing fits around and under a chafer dish shelf designed for common Sterno® cans, including those used with traditional roll-top style cover designs. The protective housing includes a receptacle for attaching portable and reusable pressurized gas containers (i.e. propane or butane tanks), a preferable electric ignition feature, and a knob for adjusting gas flow. The protective housings can be made to incorporate thermally insulating barriers to prevent external non-heating elements from overheating and causing subsequent accidental injury. Several other embodiments incorporate their own covering mechanisms to replace traditional roll-top and other common styles, improving efficiency in design and use and enhancing protection from food contamination.

### BRIEF DESCRIPTION OF THE DRAWINGS

The structure, operation, and methodology of the invention, together with other objects and advantages thereof, may best be understood by reading the detailed description in connection with the drawings in which each part has an assigned either a label and/or numeral that identifies it wherever it appears in the various drawings and wherein:

FIG. 1 is a diagrammatic perspective view of a single fan, portable, battery powered serving tray embodiment according to the invention;

FIG. 2 is an exploded diagrammatic perspective view of the embodiment of FIG. 1;

FIG. 3 is a diagrammatic perspective view of a temperature modifying source employed in the embodiment of FIGS. 1 and 2 including a fin architecture for providing increased surface area for enhanced thermal transfer and air flow control;

FIG. 4 is a diagrammatic side elevational view illustrating the flow circulation of the embodiments of FIGS. 1, 2, and 3;

FIG. 5 is a diagrammatic perspective view of a portable serving tray of the invention provided with either thermoelectric cooling or ice as the means for providing thermal control of air circulated over food products;

FIG. 6 is a diagrammatic, exploded perspective view of the portable serving tray of the invention of FIG. 5;

FIG. 7A is a diagrammatic perspective view showing a portable tray provided with a partially erected lid configuration which people can readily lift to serve themselves food products that are normally protected by the lid in a closed position;

FIG. 7B is a diagrammatic perspective view showing the partially erected lid configuration of FIG. 7A in a substantially fully erected position where food is readily accessible;

FIG. 7C is a diagrammatic view showing a portable tray provided with a lid that bears solar cells for providing power to drive electric fans;

FIG. 8 is a diagrammatic exploded perspective view of a thermoelectric heater/cooler arrangement that may be readily be incorporated in the portable tray embodiments of the invention;

FIG. 9A is a diagrammatic side elevational view of a circular architecture for a portable tray of the invention showing the flow circulation path of its protecting air curtain;

FIG. 9B is a diagrammatic exploded perspective view illustrating a circular configuration for portable tray apparatus based on the principles of the invention;

FIG. 10 is a diagrammatic exploded perspective view showing a circular portable tray with a manually moveable parasol lid that may be provided with solar cells as a feature;

FIG. 11A is a diagrammatic perspective view showing a standard catering industry chafing dish system with which embodiments of the invention may be used;

FIG. 11B is a diagrammatic exploded perspective view showing various components of the standard catering industry chafing dish system of FIG. 11A;

FIG. 11C is a diagrammatic showing a standard catering industry warmer with which embodiments of the invention may be used;

FIG. 12A is a diagrammatic perspective view of a dual fan embodiment of the invention for use with standard catering industry chafing dish systems where the location of the fans with respect to the chafing tray is fully adjustable in height and lateral spacing;

FIG. 12B is a diagrammatic perspective view showing a dual fan embodiment of the invention for use with standard catering industry chafing dish systems where the location of the fans with respect to the chafing tray is fully adjustable in height but fixed in lateral spacing;

FIG. 13 is a diagrammatic perspective view of a pair of opposed pedestal fans of the invention for use with standard catering industry chafing systems where the location of the fan pedestals with respect to the chafing tray is fully adjustable in height and lateral spacing;

FIG. 14 is a diagrammatic perspective view of a dual fan embodiment of the invention for use with standard catering industry chafing systems where the location of the fan with respect to the chafing tray is fully adjustable in lateral spacing while the height of intake and exhausts are adjustable in height, with air circulating over and under the tray;

FIG. 15 is a diagrammatic exploded perspective view of the single fan embodiment of FIG. 14;

FIG. 16 is a diagrammatic perspective view of a single fan embodiment of the invention that may be integrally formed as part of a standard catering industry chafing tray where the location of the fans with respect to the chafing tray is fixed in height and lateral spacing;

FIG. 17A is a diagrammatic side-elevational view of the embodiment of FIG. 16 show integrated with a standard catering industry chafing tray along with its attendant air flow pattern;

FIG. 17B is a diagrammatic side-elevational view of the embodiment of FIG. 17A used in conjunction with a standard catering industry warmer;

FIG. 18 is a perspective digital photograph taken from the upper left corner of a prototype pedestal arrangement similar to that shown in FIG. 13;

FIG. 19 is a diagrammatic perspective view showing a dual fan embodiment of the invention that sits atop the opening of a standard catering industry chafing tray to provide a recirculating air curtain over its food contents;

FIG. 20 is a partially exploded diagrammatic perspective view of the embodiment of FIG. 19 showing it partially removed from the top of a chafing tray;

FIG. 21 is a partially exploded diagrammatic perspective view of the embodiment of FIG. 19 showing it partially removed from the top of a chafing tray, but from a perspective different from that shown in FIG. 20;

FIG. 22A is a diagrammatic perspective view of the embodiment of FIG. 19 shown with a pair of separated locating tabs;

FIG. 22B is a diagrammatic perspective view of the embodiment of FIG. 19 looking at it from the perspective of a chafing tray opening;

FIG. 22C is an exploded diagrammatic perspective view of the embodiment of FIG. 19 showing its major components;

FIG. 23A is a diagrammatic perspective view of a differently styled version of the embodiment of FIG. 22B wherein the contours of the opposed fan housings mimic the shape of a typical chafer lid;

FIG. 23B shows two further features including a flow-directing honeycomb grill and an air sterilizing lamp;

FIG. 24 is a diagrammatic perspective view of a catalytic heater element adapted for a common serving chafer dish and stand including honeycomb grill element, protective housing, gas container, flow control valve and knob embodiment according to the invention;

FIG. 25 is a diagrammatic perspective view of a catalytic heater embodiment wherein the heating element is raised upon a truncated pyramid base which includes an integrated stand for common chafer tray dish systems;

FIG. 26 is a diagrammatic perspective view of a catalytic heater embodiment wherein two heating elements are adapted to fit where Sterno® cans are traditionally placed;

FIG. 27 is a diagrammatic perspective view of a catalytic heater embodiment herein the heating unit is adapted for use with traditional roll-top cover designs;

FIG. 28 is a diagrammatic side-elevational view of a catalytic heater embodiment shown in combination with a traditional roll-top cover design;

FIG. 29 is a diagrammatic side-elevational view of a catalytic heater element provided with thermal insulating structure;

FIG. 30A is a diagrammatic side-elevational view of a serving food tray cover with telescoping hood sections;

FIG. 30B is a diagrammatic perspective view of the serving food tray cover with its telescoping hood sections in their fully open position;

FIG. 31A is a diagrammatic perspective elevational view of a serving food tray cover embodiment with slats connected together flexibly for compact storage so that space is available underneath the tray stand for catalytic and other non-electric heating mechanisms;

FIG. 31B is an enlarged diagrammatic side-elevational view of the slats of FIG. 31A connected together flexibly;

FIG. 31C is a diagrammatic side-elevational view of an embodiment of a cover design using strong flexible material in place of the slats used in the embodiment shown in FIGS. 31A and 31B;

FIG. 32A is a diagrammatic perspective view of an embodiment of a serving food tray cover with dome-shaped sections that pivot upwards and remain stationary when fully opened, so that space is available underneath the tray stand for catalytic and other non-electric heating mechanisms;

FIG. 32B is a diagrammatic perspective view of the embodiment shown in FIG. 32A when the dome-shaped cover sections are in their open positions;

FIG. 33A is a diagrammatic perspective view of the embodiment shown in FIG. 32A with the dome-shaped sections removed to show additional components for the pivoting and stopping features of the sections; and,

FIG. 33B is a diagrammatic perspective view of part of the dome-shaped cover of the embodiment shown in FIG. 32A showing the contact component of the cover's stopping feature.

### DETAILED DESCRIPTION

This invention relates to portable tray apparatus and methods for displaying, serving, and conserving food products. One aspect of the invention is directed to apparatus that broadly comprises means for supporting food so that is readily accessible and visible to a person and means for directing a circulating stream of thermally controlled air over the food to aid in conserving its initial state of preparation and keeping it free of insects and other airborne sources of food contaminants. Several embodiments of the invention are provided that differ in geometry, the number and configuration of fans, power supply, and thermal control features.

In another aspect of the invention, catalytic heating systems are configured and arranged to provide non-electric, non-open flame heat sources for use with chafing dish systems widely used in the catering industry as well as fully integrated stand alone heating systems that can support conventional chafing dish systems directly.

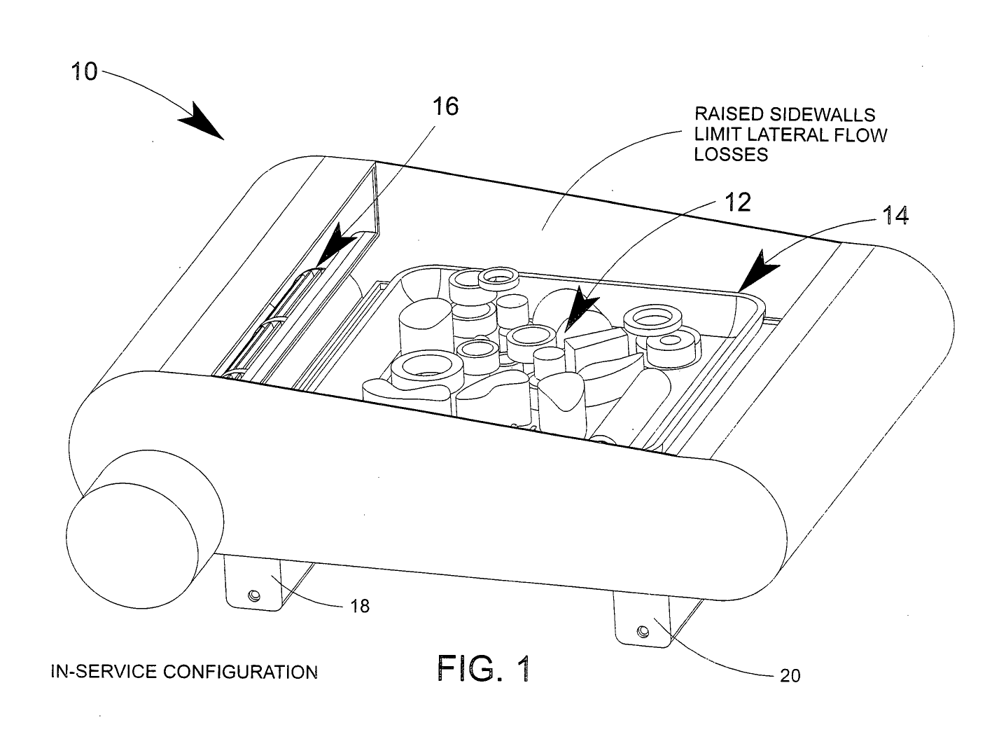

Reference is now made to FIGS. 1 through 4 which diagrammatically show generally at 10 a portable, battery powered serving tray having a specially shaped eutectic salt container to provide thermal control of air circulated over food products 12 resident in a tray 14 that sits recessed inside of the surrounding raised walls provided in the tray. A squirrel cage type electric fan 16 is provided to generate a curtain of cool air over the top of the food. Electric power for the fans is provided by batteries or the like that reside in support legs 18 and 20.

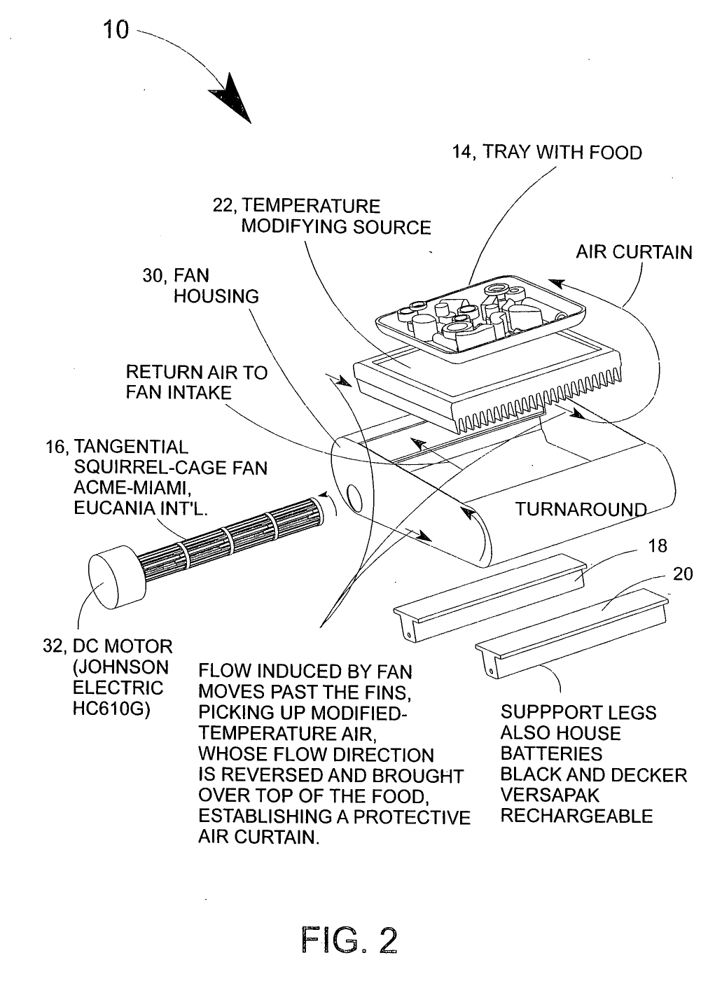

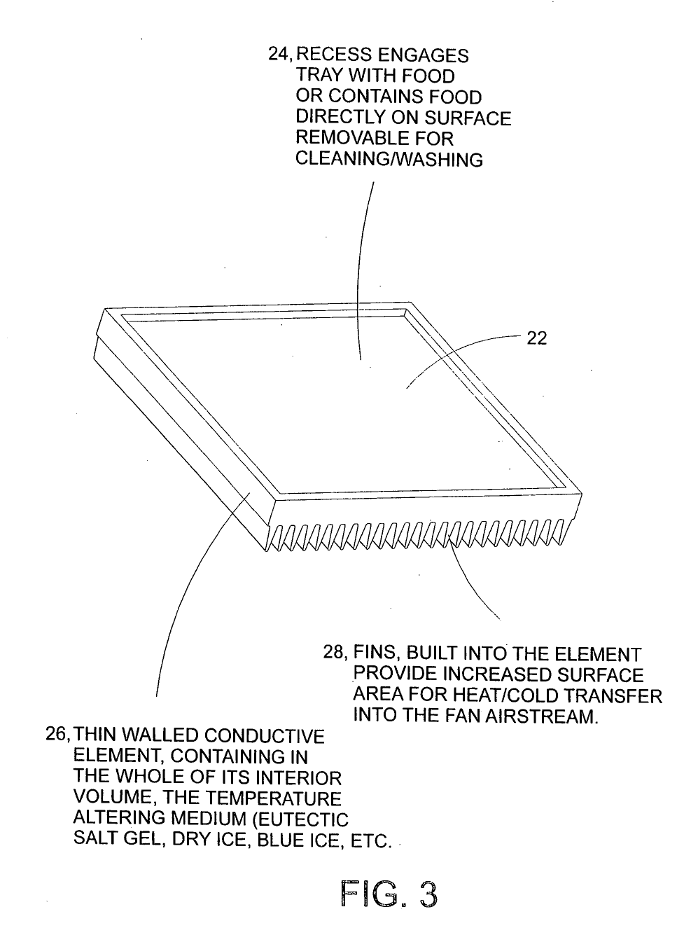

As best seen in FIG. 2, food 12 sits in tray 14 that in turns rests atop of a temperature-modifying source 22. FIG. 3 shows that temperature-modifying source 22 is provided with a recess 24 for receiving tray 14 and its food contents 12. Underneath the recess 24 is a thin walled conductive element formed of a thermally conductive material within which resides a temperature altering medium such as, for example, a eutectic salt gel, dry ice, blue ice, or the like. And, formed beneath conductive element 26 are a series of fins 28 to define flow channels in conjunction with the base of a fan housing 30 and to provide increased surface area to promote thermal transfer between the thermal source resident in conductive element 26 and air flowing past the surface of fins 28.

As also seen in FIG. 2, fan 16 is preferably of the squirrel-cage type manufactured by, for example, Acme-Miami and Eucania International. It is powered by a DC motor 32 (Johnson Electric HC610G, or the like) whose power may be derived from dry cell batteries, rechargeable batteries, such as the Black and Decker Verspak or the like, any of which are conveniently packaged in support legs 18 and 20 so that they can be easily replaced. A DC power supply may also be used to drive DC motor 32.

Temperature modifying source 22 may also be an integrally molded plastic container in which reusable eutectic salts are conveniently placed for ease of freezing and cleaning.

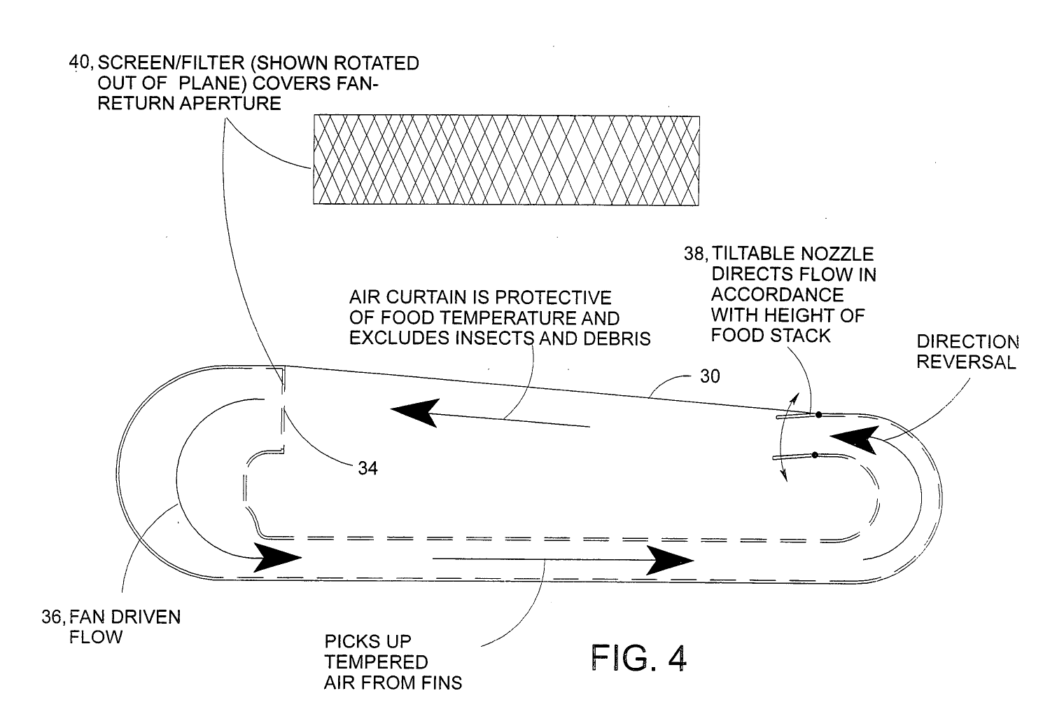

Reference is now made to FIG. 4, which shows fan housing 30 in elevation. As seen there, fan 16 provides a circulating air curtain over the top of food by ingesting air through an intake 34, which may be covered by a screen 40, and flowing it through the air channels defined underneath the tray by fins 28 and the bottom surface of the fan housing 30 after which it emerges from an exit nozzle 38 that may be articulated to provide directional control as suitable. The air curtain is protective of food and excludes insects and foreign particulate matter that may be sources of contamination and disease while providing while still providing visible and physical access to it.

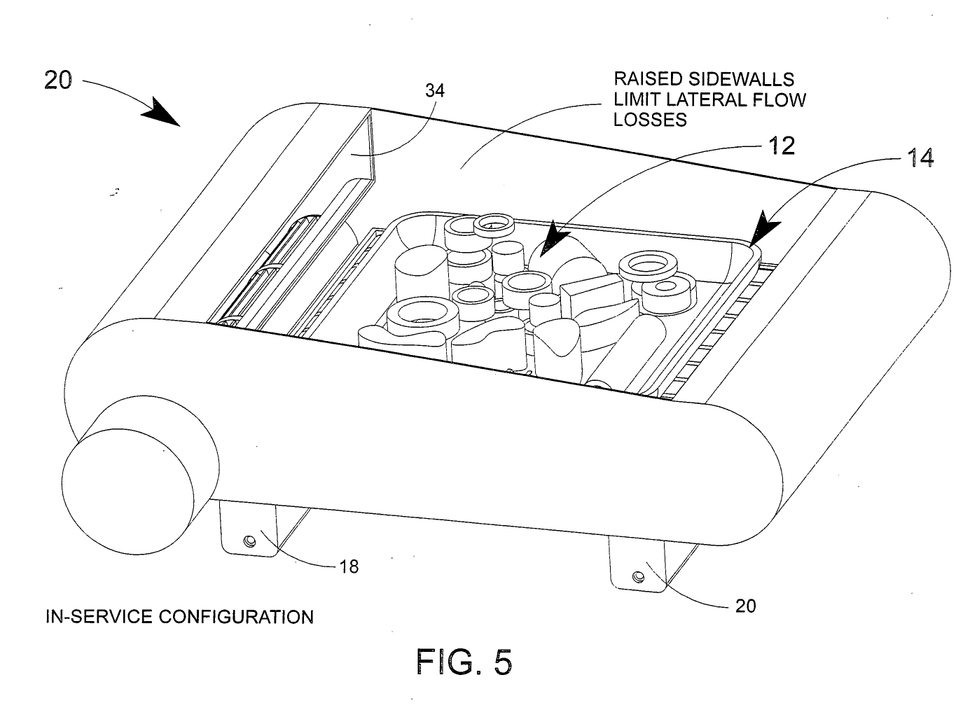

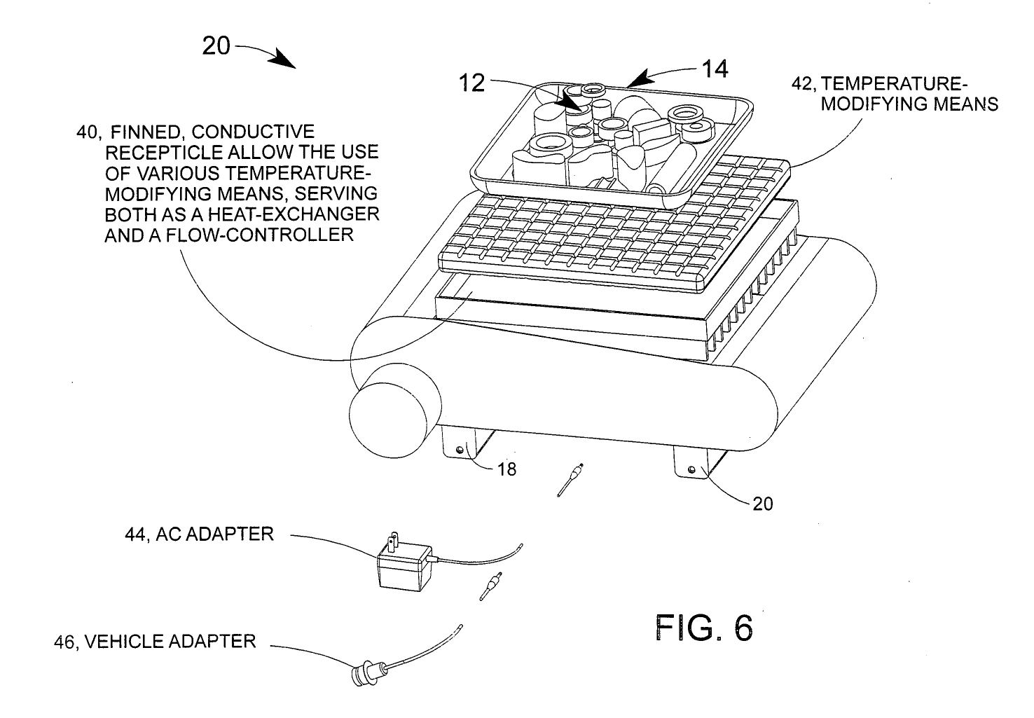

Reference is now made to FIGS. 5 and 6, which diagrammatically show a portable serving tray 20, provided with either thermoelectric cooling or ice as the means for providing thermal control of air circulated over food products. As seen there, tray 20 is similar in many respects to tray 10 but differing in its thermal source. Here, temperature-modifying means 42 sits in a finned conductive receptacle 40 that permits temperature-modifying means 42 to take on various forms. For example, the temperature modifying means here may be a thermo electric cooler or heater that is powered by an AC adapter 44 or a vehicle adapter 46. Alternatively, the previously described passive thermal sources may also be used.

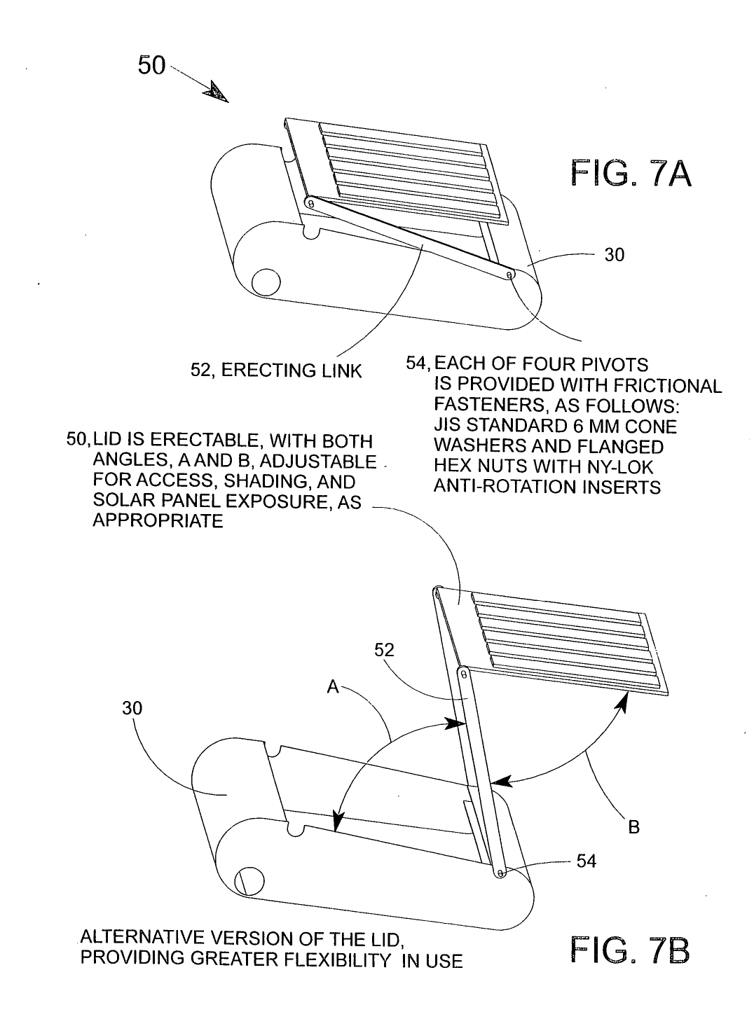

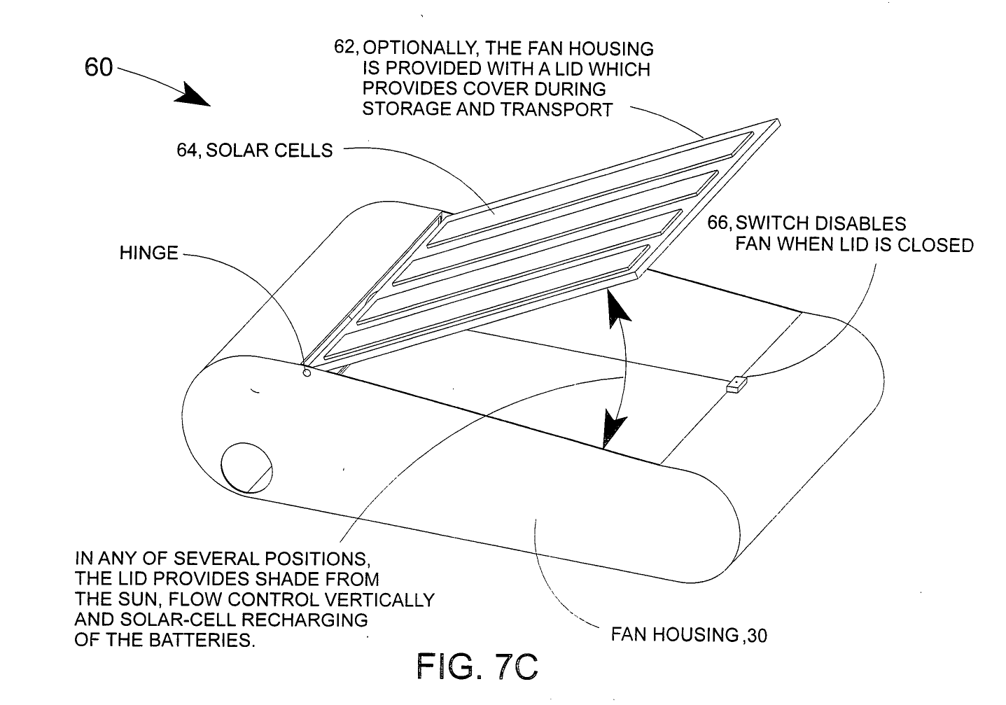

Reference is now made to FIGS. 7A and 7B which diagrammatically show a portable tray provided with various lid configurations which people can readily lift to serve themselves food products that are normally protected when the lids are in a covering or closed position. As seen, a lid 50 is pivotally mounted about pivots 54 to fan housing 30 via erecting links 52. The pivots are provided with frictional fasteners to permit the lid to be selectively fixed in place by the user.

Reference is now made to FIG. 7C which diagrammatically shows a portable tray 60 provided with a hinged lid 62 that may bear solar cells 64 for providing power to drive electric fans. In FIGS. 7A, 7B, and 7C, the lids can be transparent so that people and see the underlying food products, and switches such as that shown at 66 may be provided to disable fans when the lid is closed.

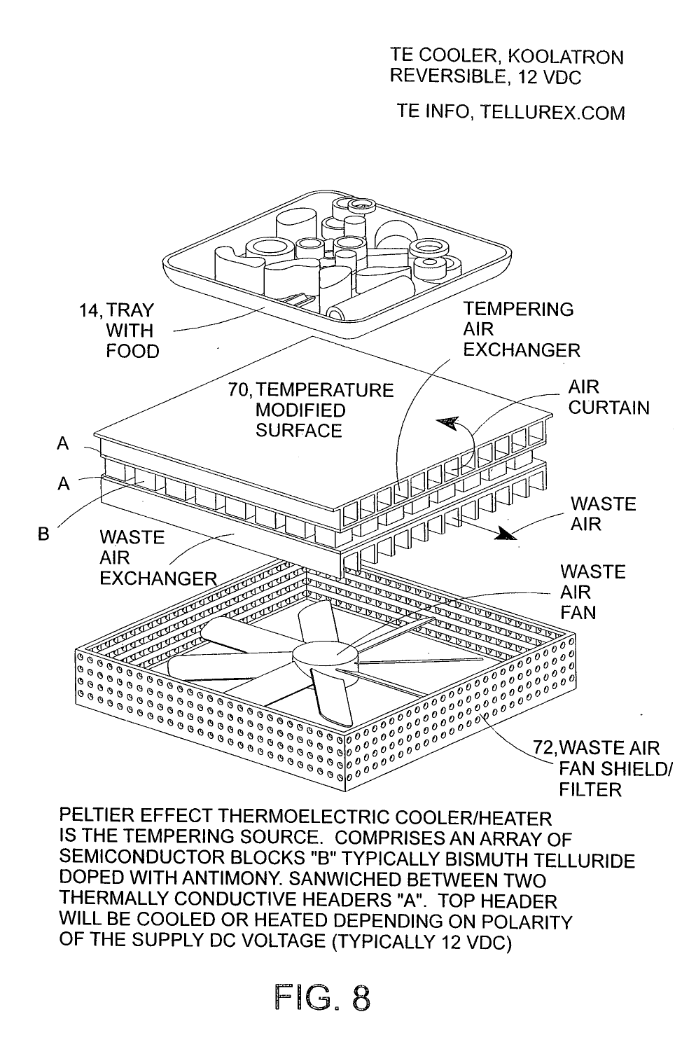

Reference is now made to FIG. 8, which diagrammatically shows a thermoelectric heater/cooler arrangement that may be readily incorporated in the portable tray embodiments of the invention. Here, the temperature-modifying source 70 comprises an array of thermoelectric blocks B (typically bismuth telluride doped with antimony) sandwiched between a pair of thermally conductive headers A. Top header A is cooled or heated depending on the polarity of the powering source. A waste air fan resident in a shielding housing that may be equipped with a filter carries off waste air.

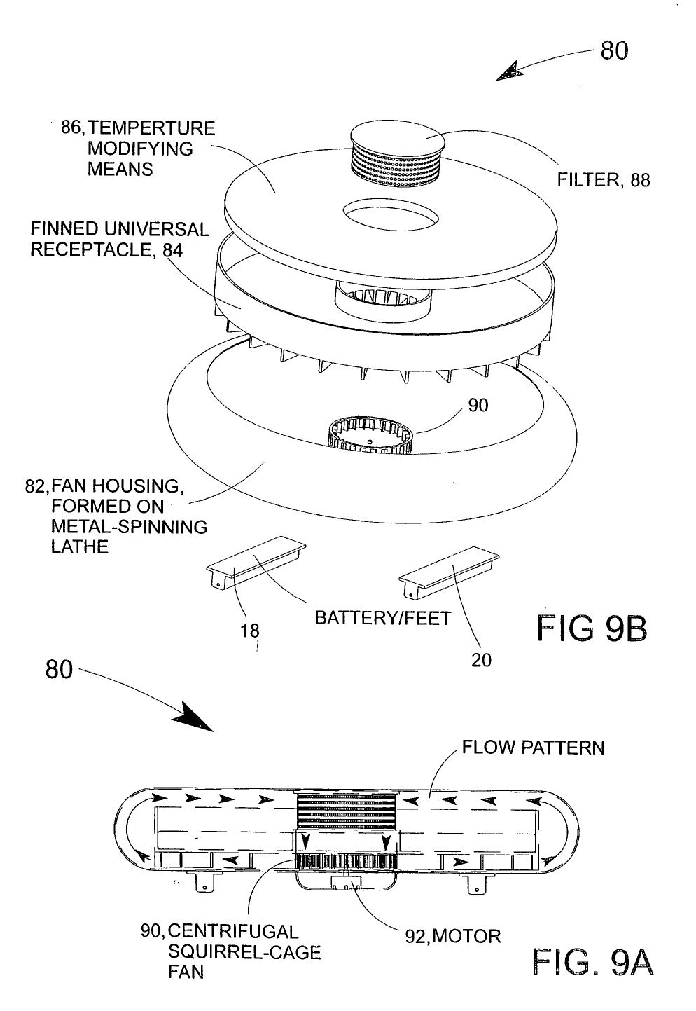

Reference is now made to FIGS. 9A and 9B which diagrammatically illustrate a circular configurations of a portable tray apparatus 80 based on the principles of the invention. Here, tray 80 includes circular fan housing 82, finned universal receptacle 84, temperature modifying means 86, filter 88, and centrifugal squirrel-cage fan 90 which is driven by motor 92 which, in turn, is powered by battery feet 18 and 20. FIG. 9A shows the circulating air flow with fan 90 directing flow radially up and over food and returning via a centrally located vertical path that is filtered by filter 88.

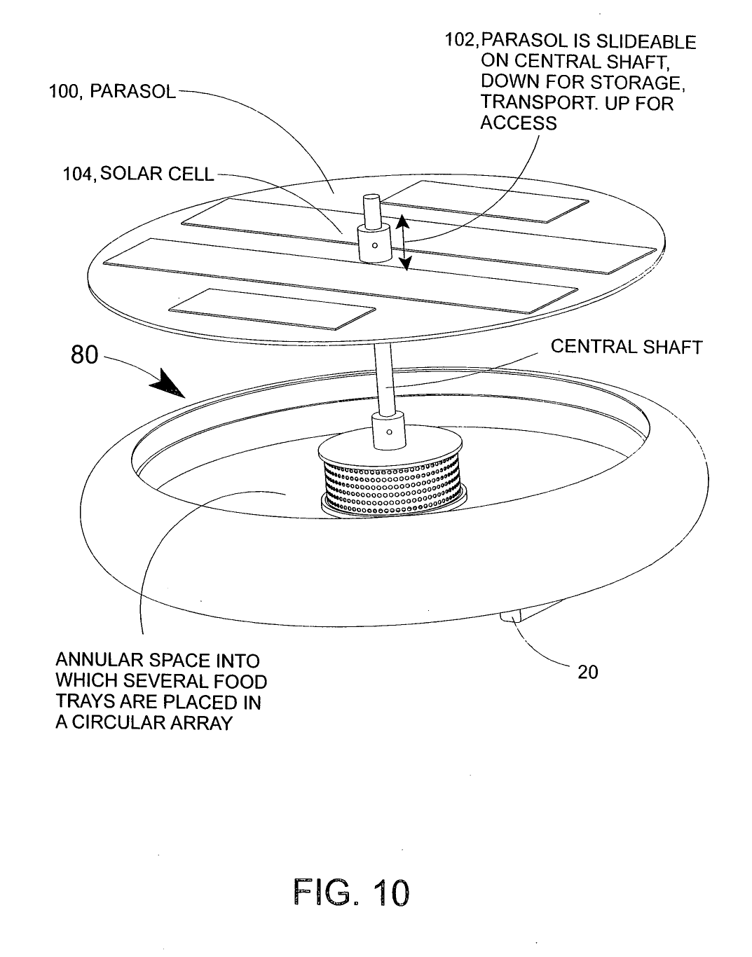

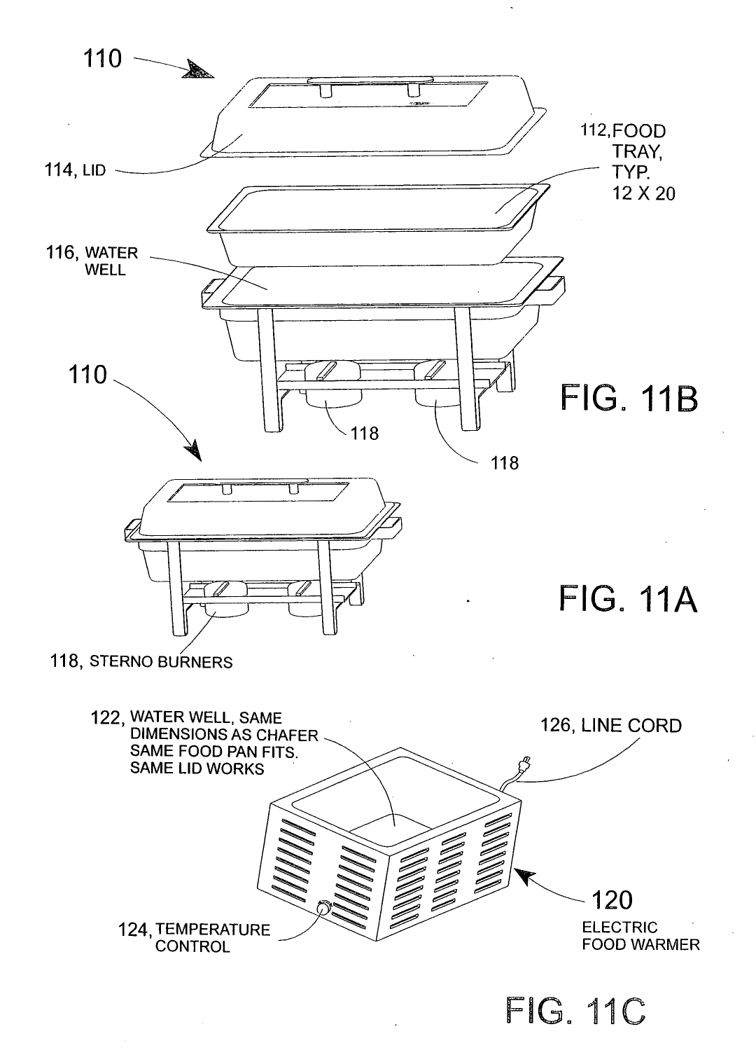

Reference is now made to FIG. 10 which diagrammatically shows a circular portable tray such as that at 80 that is provided with a parasol lid 100 that is slidably mounted for manual movement between open and closed positions to provide access to food that is resident in one or more food trays that have been placed in the annular space provided within tray 80. Solar cells 104 may be placed atop parasol 100 to provide power to charge, recharge or supplement needed power requirements. Reference is now made to FIGS. 11A and 11B which diagrammatically show a standard catering industry chafing dish system with which embodiments of the invention may be used. As seen, chafing system 110 has as major components a food tray 112 with a covering lid 114. Tray 112 sits in a water well 116 whose water is heated by a pair of Sterno® burners or the like. FIG. 11C diagrammatically shows a standard electric catering industry warmer 120 for receiving food trays 112. Here, a water well 122 has its water heated to controlled temperatures via a temperature control 124. The unit is line powered by line cord 126. As will be seen, embodiments of the invention are provided that are particularly suitable for use with food trays of the type represented by tray 112.

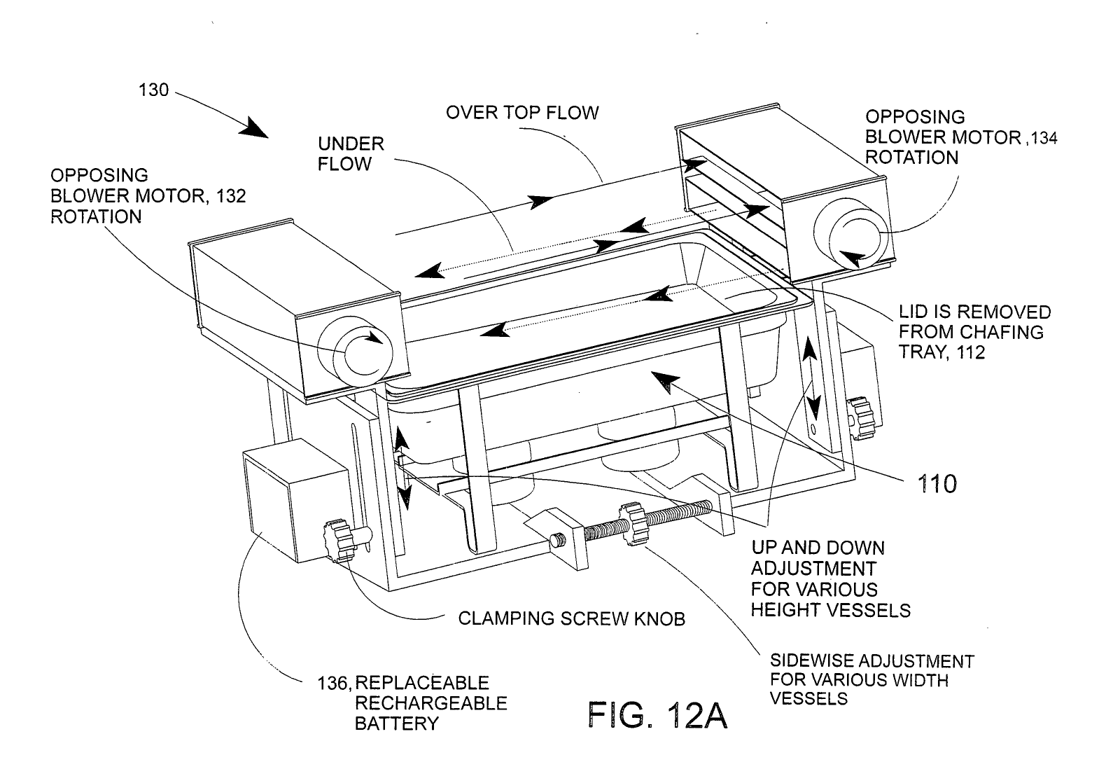

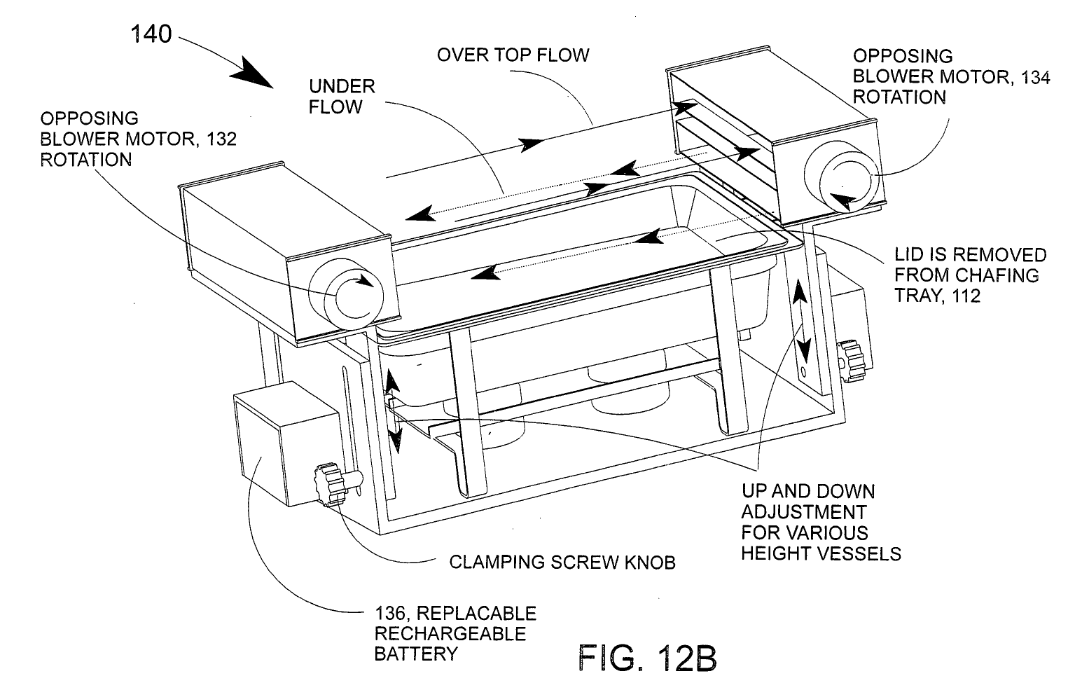

Reference is now made to FIG. 12A which diagrammatically shows a dual fan embodiment of the invention for use with standard catering industry chafing systems where the location of the fans with respect to the chafing tray is fully adjustable in height and lateral spacing. Here, apparatus 130 includes a pair of opposing blowers 132 and 134, which when actuated create under and over top air curtains flowing in opposite directions and recalculating over the top of a chafing dish tray 112 from which the lid has been removed. Blowers 132 and 134 are mounted on top of an adjustable support arrangement that permits adjustment of their vertical and lateral position with respect to a tray 112. Power may be provided by a replaceable or rechargeable battery module 136.

Reference is now made to FIG. 12B which diagrammatically shows a dual fan embodiment of the invention also for use with standard catering industry chafing dish system. Here, apparatus 140, similar to apparatus 130, is provided where the location of opposed fans 132 and 134 with respect to the chafing tray 112 is fully adjustable in height but fixed in lateral spacing. Otherwise, apparatus 140 has elements otherwise in common with apparatus 130.

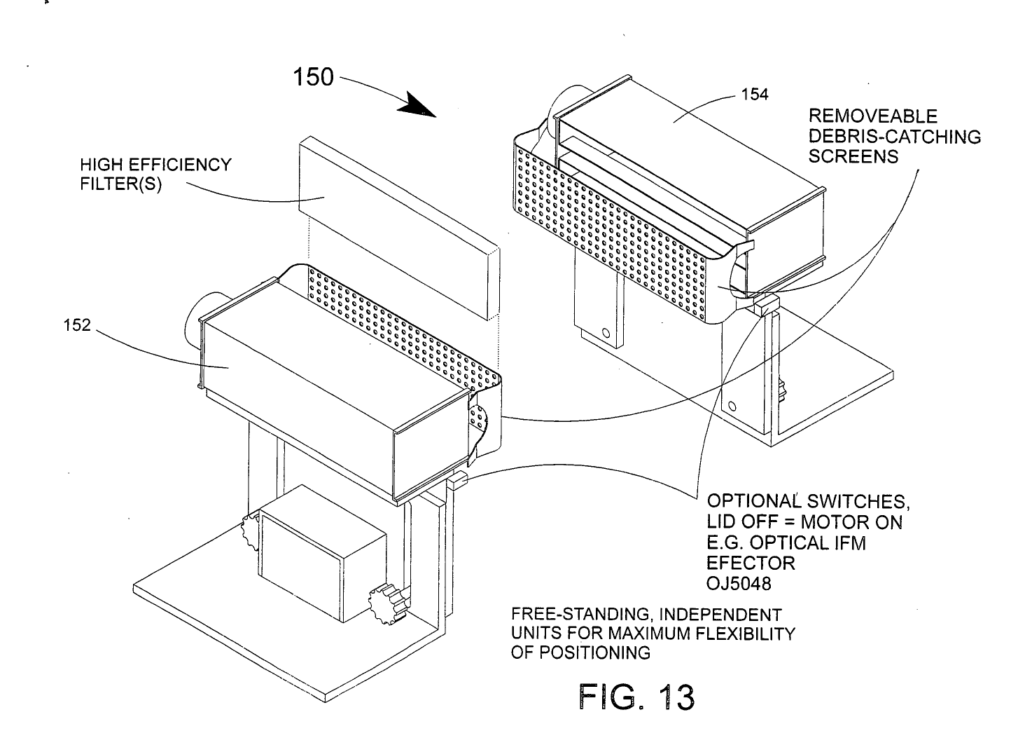

Reference is now made to FIG. 13, which diagrammatically shows a dual pedestal fan embodiment of the invention 150 for use with standard catering industry chafing dish systems. Here, a pair of freestanding, independent blower units 152 and 154 are provided for maximum flexibility in positioning. As before, flow is recirculating and opposite in direction. The location of the fan pedestals with respect to chafing tray 112 is fully adjustable in height and lateral spacing.

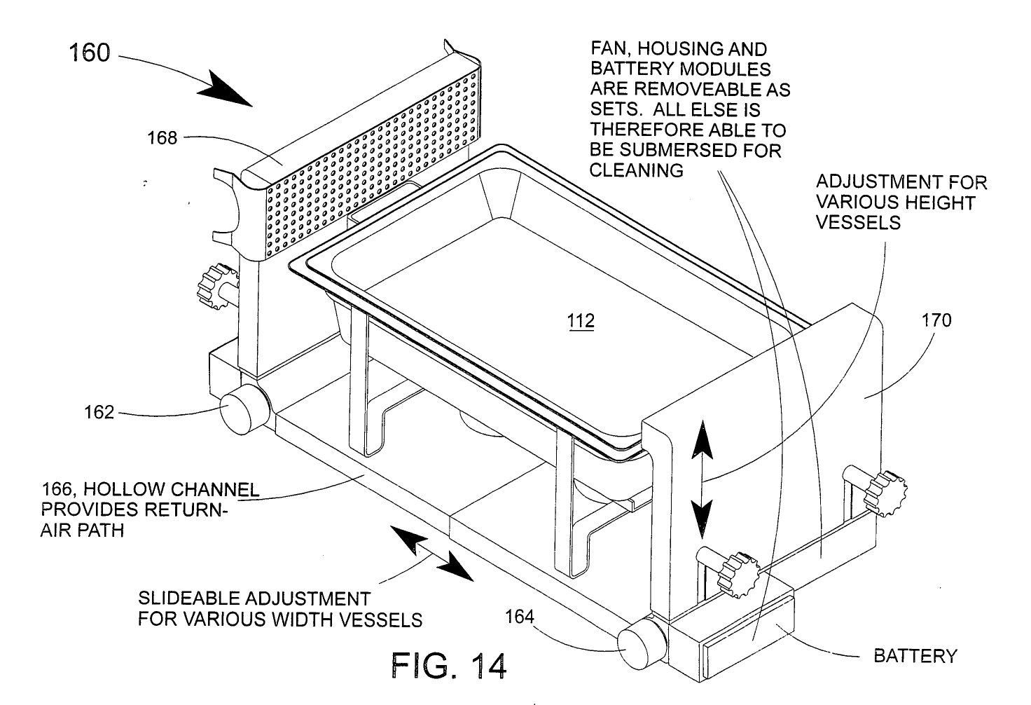

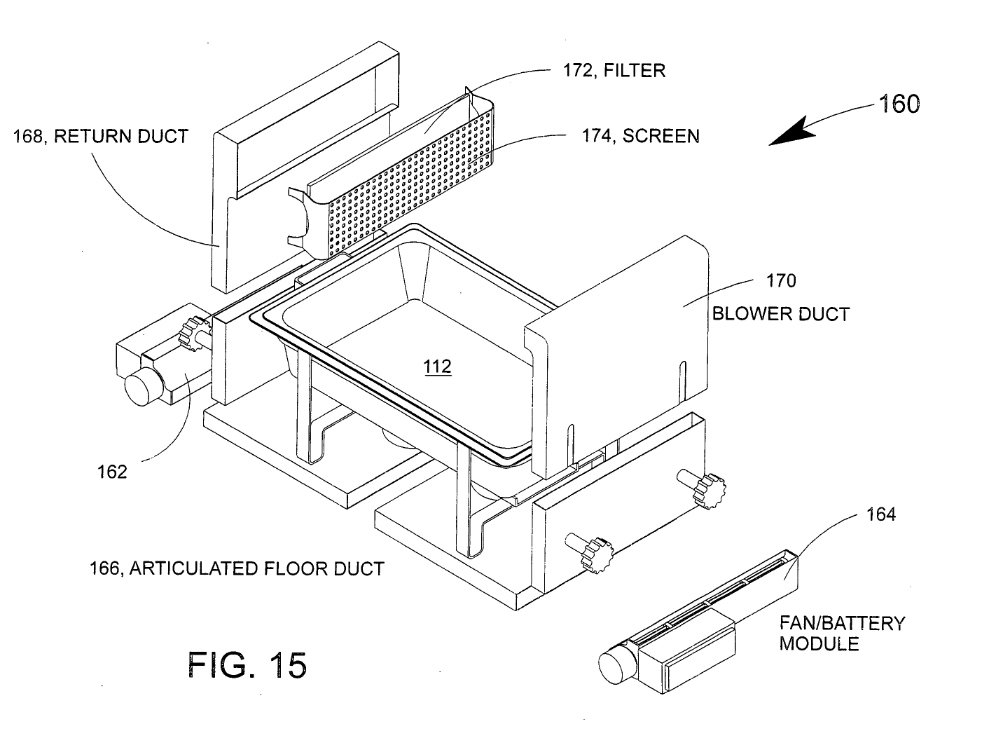

Reference is now made to FIGS. 14 and 15 which diagrammatically show a dual fan apparatus 160 of the invention for use with standard catering industry chafing dish systems where the location of the fans with respect to the chafing tray is fully adjustable in lateral spacing and the height of their intake and exhausts are fully adjustable in height air circulating over and under the chafing system. As seen, apparatus 160 has two blowers 162 and 164 that reside at either end of a laterally adjustable base or floor duct 166. Blower 162 has a vertically extending snorkel 168, adjustable in height, to take in or return air, and blower 164 takes air within floor duct 166 and exhausts it via a vertically extending adjustable exhaust port or blower duct 170 for circulation around chafing tray 112 and thus back underneath the entire chafing system. Filtering is provided at the intake side of snorkel 168 via a filter 172 and screen 174.

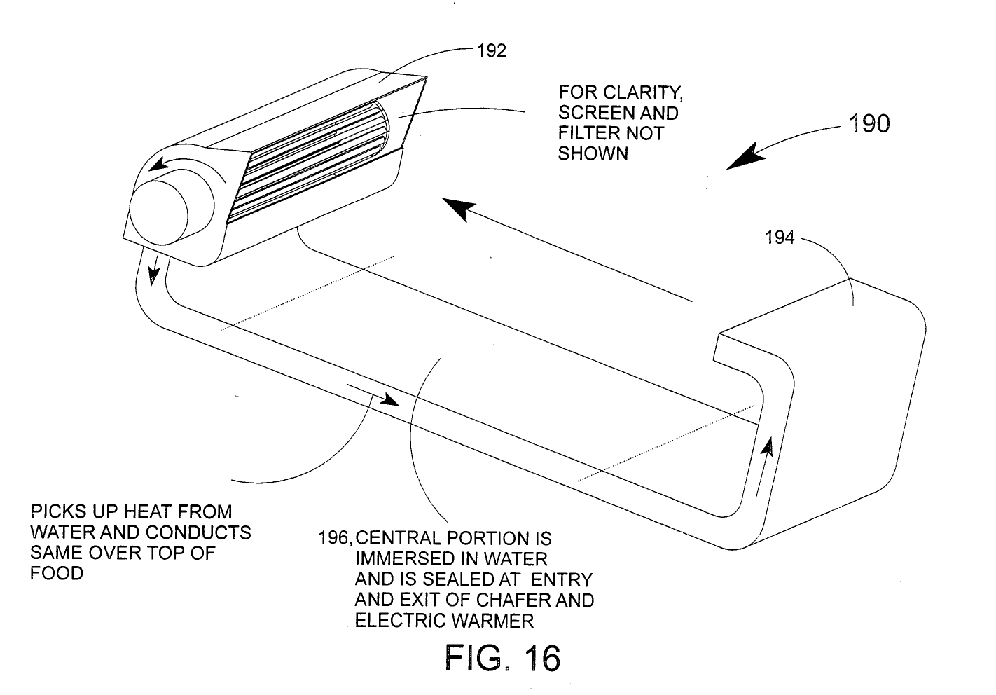

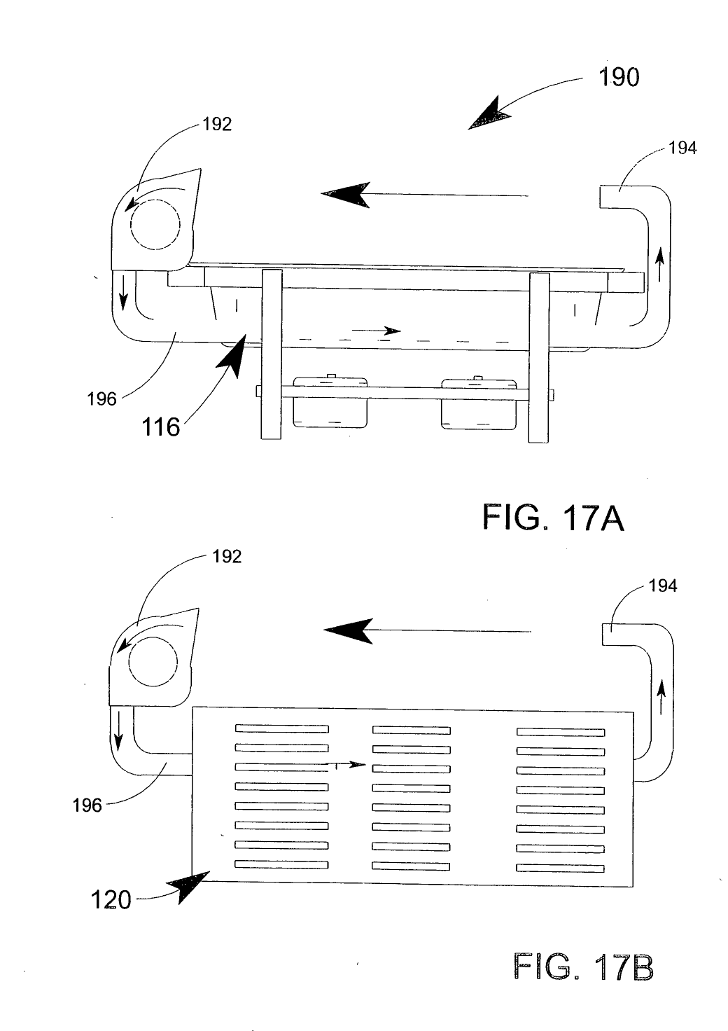

Reference is now made to FIGS. 16, 17A, and 17B which diagrammatically shows a single fan apparatus 190 of the invention integrally formed as part of either a standard catering industry chafing dish system 116 or electric tray warmer 120 where the location of the fans with respect to the chafing tray is fixed in height and lateral spacing. As best seen in FIG. 16, apparatus 190 comprises a single fan unit 192 located at the entrance to a return duct and sitting just above a tray 112. A blower duct 194 is provided opposite to this, and air circulates over a tray 112 and through a central duct 196 that is integrally formed in the bottom of the water well portion of either the chafing dish system 116 or the electric warmer 120. The central portion 196 is sealed at entry and exits to prevent water leakage.

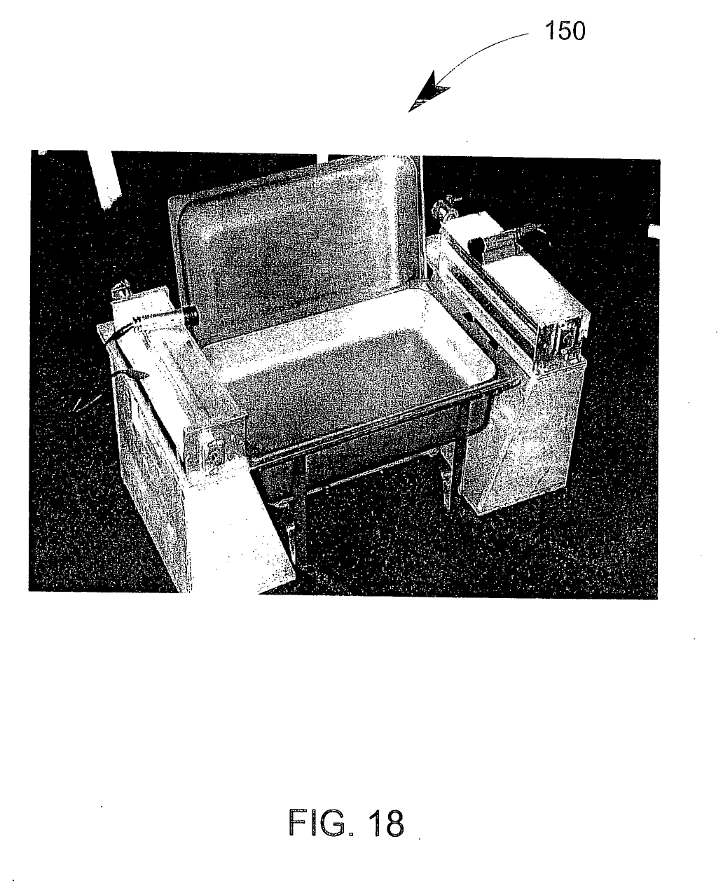

Reference is now made to FIG. 18, which shows is a digital photograph of a prototype pedestal arrangement similar to the embodiment described in connection with the description of FIG. 13.

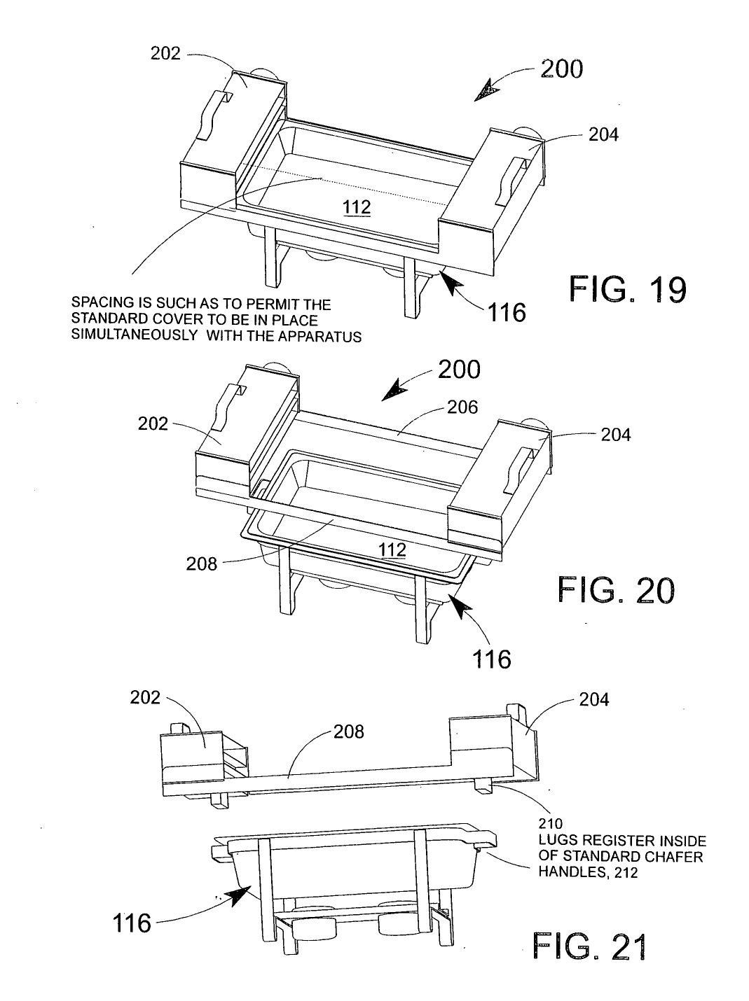

Reference is now made to FIGS. 19 through 22C, which show a dual fan apparatus 200 of the invention that sits atop the opening of a standard catering industry chafing tray 112 to provide a recirculating air curtain over its food contents. Here, FIGS. 19, 20, and 21 illustrate apparatus 200 as having a pair of rectangularly shaped opposed fan units 202 and 204 that are connected by a pair of opposed rails 206 and 208 that fit over the lip of a tray 112 and are laterally fixed in place via an opposed pair of vertically depending lugs 210 that fit with handles 212 of the frame for receiving and supporting the water well 116.

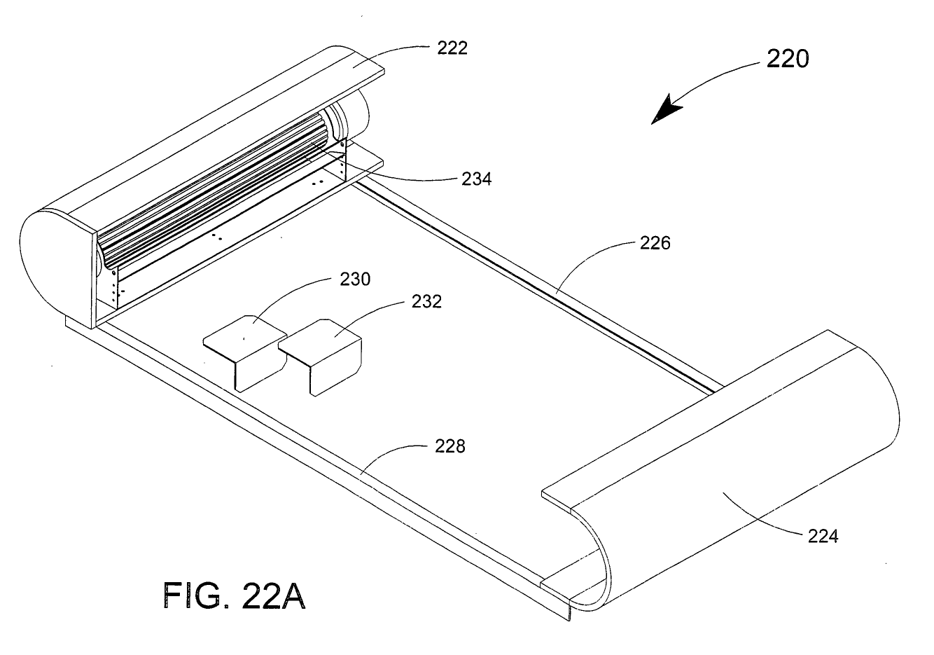

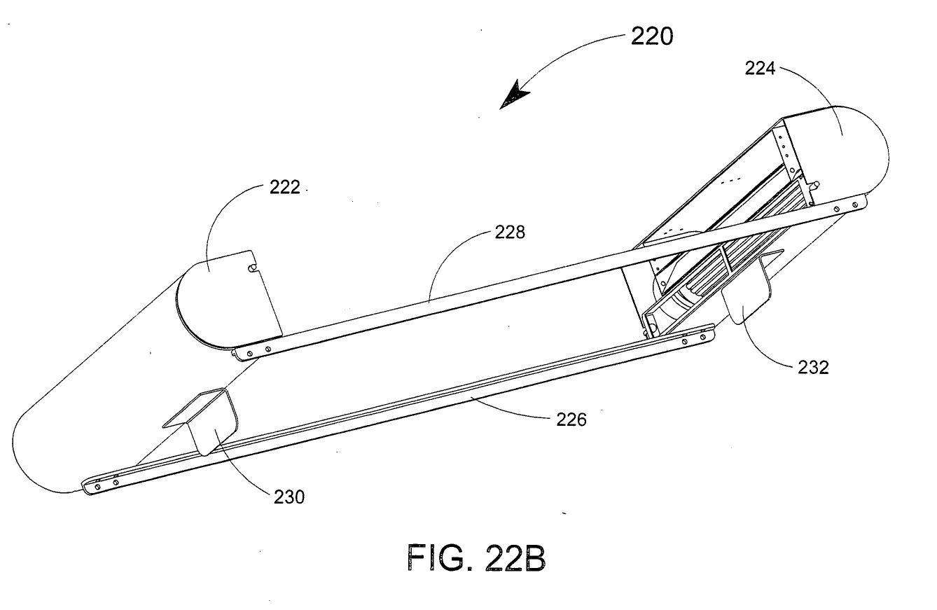

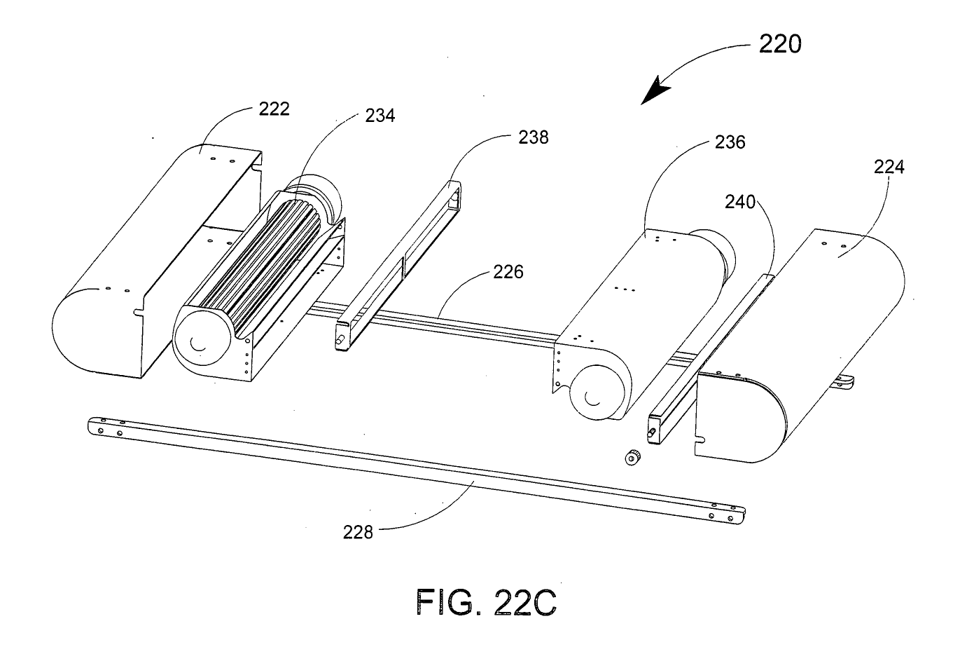

Reference is now made to FIGS. 22A, B, and C which diagrammatically show portable apparatus 220 comprising a pair of opposed fan assemblies 222 and 224 that are structured as before to provide a circulating air curtain over the top of a food tray 112. Here, the housings of the fan assemblies 222 and 224 are curved rather than rectangular as before. Fan assemblies 222 and 224 are connected by opposed right angle rails 226 and 228 that are dimensioned to fit over the outside edge of a tray 112 and are positioned laterally by tabs 230 and 232 that operate as before. As best seen in FIG. 22C fans 234 and 236 are mounted upside down with respect to one another to provide the circulating flow. Filter carrying brackets 238 and 240 are provided. It will be appreciated that one or both of the connecting rails may act as a wire race for supplying power or switching to the motors of fans 234 and 236. In this connection, suitable switches may be provided to sense the presence or absence of a lid to automatically power the fans on or off when the lid is removed or replaced to thereby conserve power. Such switches may be micro, proximity, or optical types.

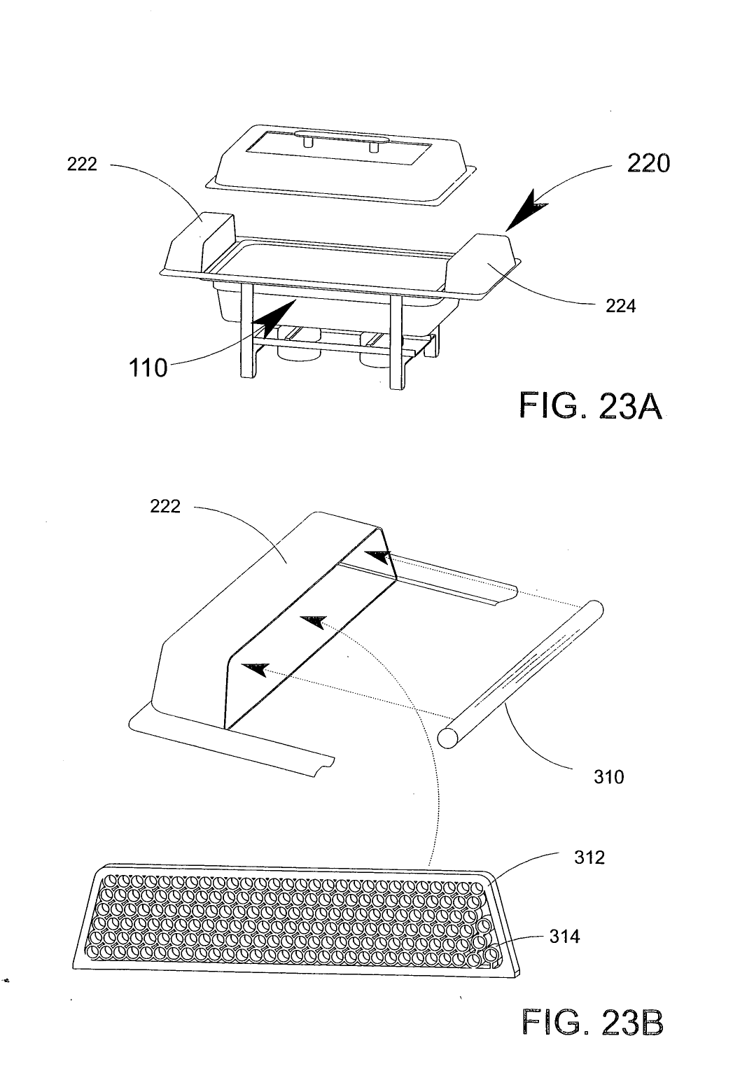

Reference is now made to FIG. 23A which shows a perspective view of the portable apparatus 220, mounted on the standard chafer assembly 110. In this configuration, the outer contours of the opposed fan assemblies 222 and 224 have been redesigned to more closely match the shape of the standard chafer cover.

Reference is now made to FIG. 23B. One opposed fan assembly is shown in a partially exploded perspective view, to mount two components, added to those previously described.

First, a flow-directing grille 312, a honeycomb structure comprising a multiplicity of tubular members 314, is firmly attached in the front opening of the fan housing. The grille 312, is shown magnified and out of plane for clarity. The grill has two utilities: The tubular structure is effective to control the directionality of the previously described recirculating air curtain, keeping the flow parallel. Additionally, the grille is effective to prevent accidental contact with the rotating fan blades.

The second component added is a sterilizing lamp 310, mercury or xenon arc, pulsed or steady state, effective to sterilize the recirculating air curtain. Ultraviolet radiation is effective, with attendant generation of hydroxyls OH and ozone O3, to eliminate harmful viruses, vapors, germs, bacteria, mold spores, fungi and anthrax derivatives from the air. Devices are available from Biozone, Inc. of Englewood, Colo., from Wedico UV Systems, U.K. and others.

Having described various aspects of the invention directed to cooling systems, attention is now drawn to those aspects of the invention that deal with heating systems for presenting and preserving food. One of the embodiments is especially configured to slide under a conventional chafing dish, one to replace existing support stand and Sterno® tray, and one over which an existing Sterno® stand and tray assembly may be placed with the catalytic heating units entering from below. Other embodiements are additionally adapted to be compatible with common serving tray configurations, such as the “roll-top” style. Additional embodiments incorporate serving mechanisms to be more efficiently integrated with catalytic and other non-electric heating units and are suited to better protect food from incidental contamination.

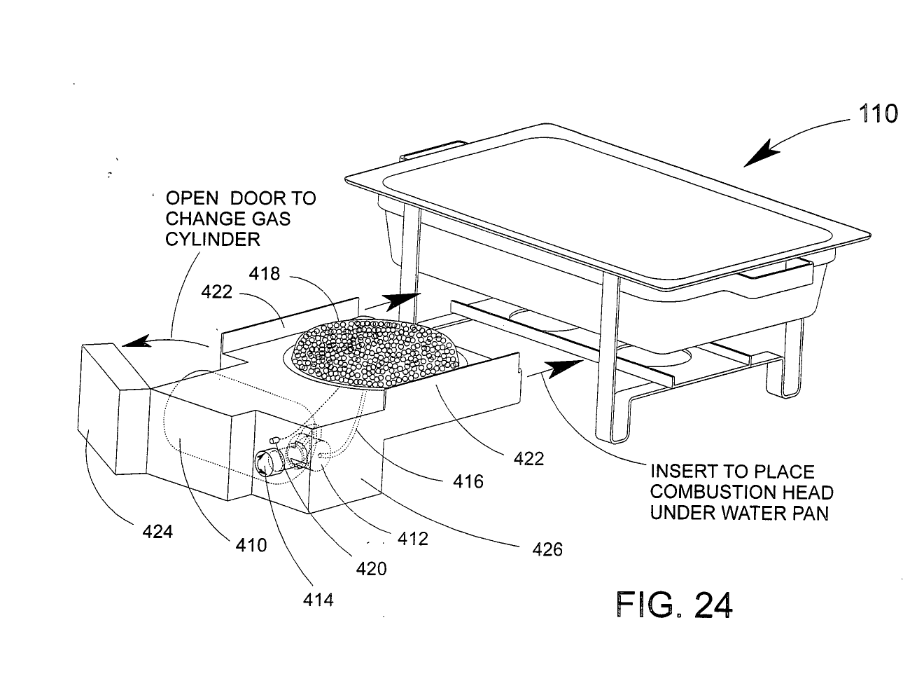

Reference is now made to FIG. 24 which shows a perspective view of an embodiment of a portable catalytic heater assembly, designated at 400, for use with a standard catering industry chafing tray 110. The assembly 400 slides underneath the chafing tray 110 where catalytic heater 418, from which heat radiates, is positioned slightly below chafing tray 110. Panels 422 are provided to keep heat directed upwards toward chafing tray 110. Valve and regulator assembly 412 are provided to control gas flow from gas supply tank 410 through supply line 416 to catalytic heater 418. Flow adjustment knob 414 may provide a means for an operator to manually adjust the rate of flow through valve 412. Button 420 permits the operator to activate an electric ignition system that initially starts the chemical reaction by which the catalytic heater converts fuel (propane or butane) to heat in a well-known manner.

In one embodiment, the catalytic system can use platinum to convert propane to heat energy. The propane is brought into contact with air and the platinum catalyst, resulting in a chemical reaction which generates heat. This catalytic process produces much less and/or fewer gases (such as nitrous oxide or carbon monoxide) than traditional flame or radiant combustion systems. The process can be regulated to generate heat at temperatures of 850 degrees F. or less, below the ignition point of most flammable materials. This allows a catalytic heater to be used in many indoor environments that have moderate levels of ventilation. An embodiment can alternatively be combined with a built-in pressure regulator that maintains constant heat output regardless of altitude or temperature.

Housing 426 is provided to protect tank 410 and valve assembly 412 from damage and provide an aesthetic cover for keeping in components hidden from view. Handle 428 provides a means for sliding assembly 400 back and forth from beneath chafing tray 110. Handle 428 also serves as a means for protecting knob 414 from incidental adjustment and damage. Panel 424 is arranged in pivoting fashion for movement between open and closed positions. When opened, tank 410 can be inserted and removed and when closed, panel 424 provides a means for protecting tank 410 during operation and transport.

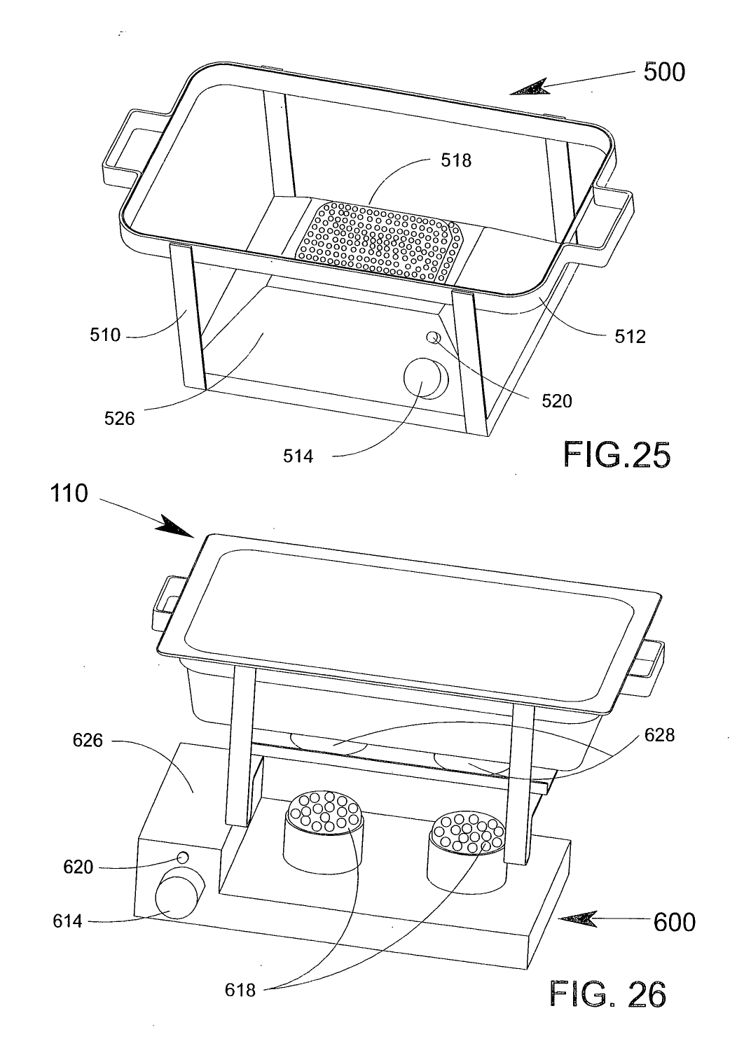

Reference is now made to FIG. 25, which shows a perspective view of an embodiment of a portable catalytic heater assembly, which is designated at 500. Assembly 500 is a fully integrated, stand-alone unit comprising supporting frame elements 512 and 510 for a standard chafing tray 110. Here, catalytic heater 518, now rectangular shaped, is raised slightly above and centered within a truncated pyramidal shaped protective housing 526 shaped to allow incidental spillover of material to be directed down and away from catalytic heater 518. Flow adjustment knob 514 provides a means for an operator to manually adjust the rate of flow through valve 412. Switch 520 provides a means for an operator to provide required initial ignition of the catalytic conversion process. Reference is now made to FIG. 26 which shows a perspective view of an embodiment of a portable catalytic heater assembly, designated at 600, for use with a standard catering industry chafing tray 110. A standard chafing tray 110 can be placed atop assembly 600 so that catalytic heater elements 618 slide through openings for standard Sterno® cans, from which heat is radiated. Flow adjustment knob 414 provides a means for an operator to manually adjust the rate of flow through valve 412. Switch 420 provides a means for an operator to initially start the catalytic heating process without requiring use of a match. In typical embodiments, a small amount of fuel may initially be ignited to heat the catalyst to a sufficient temperature for starting the catalytic process. A method for generating the igniting spark could employ, for example, a common piezoelectric device. Housing 626 is provided to protect a tank 410 and valve assembly 412 from external damage and provide an aesthetic covering.

The fuel content of the butane or propane, as the case may be, in the tanks used in the various embodiments may be monitored directly with various weighing arrangements or indirectly by monitoring temperature. In either case, external signals can be provided to an operator indicating a low fuel condition. Alternatively, full tanks can be installed at the beginning of each event as needed, and these can be obtained from a supplier or filled locally from a storage tank on the caterer's facilities.

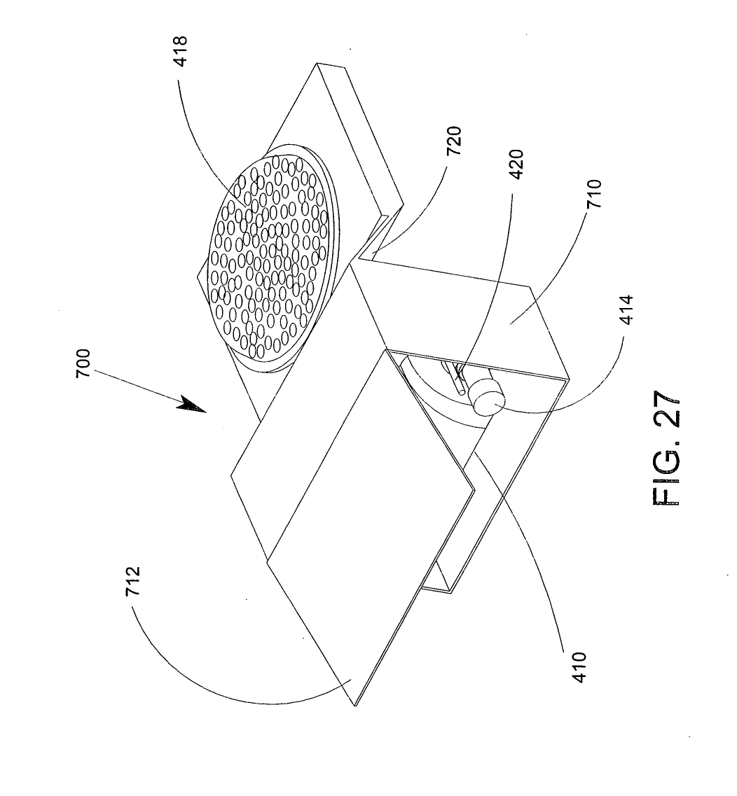

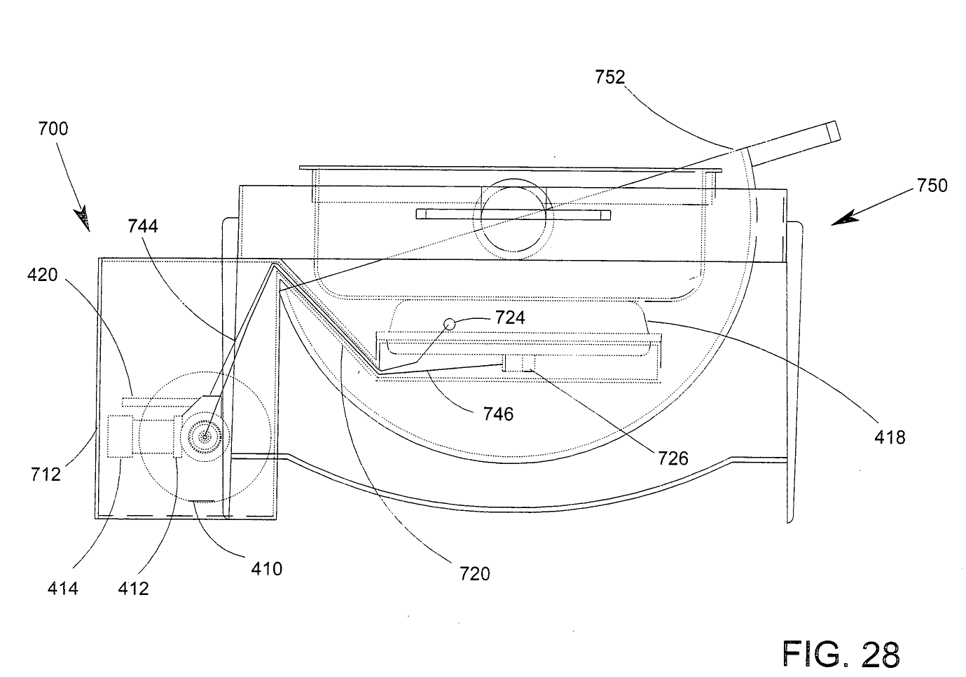

Reference is now made to FIGS. 27 and 28, which diagrammatically show an additional embodiment of a portable catalytic heater assembly. The embodiment, designated at 700, accommodates the traditional roll-top serving dish mechanism of the type designated at 750 in FIG. 28. Assembly 700 is also a fully integrated, stand-alone unit comprising support frame and enclosure element 710 and hollow narrowed down section 720, which mechanically connects to catalytic heater 418. Narrowed down section 720 is designed to lead to catalytic heater 418 while not interfering with rolltop mechanism 750. Enclosure element 710 protects heater elements, canisters, and controls contained inside from incidental contact and supports narrowed down section 720. Access door 712 can be opened to allow for canister 410 replacement and operator access to flow adjustment knob 414 and ignition switch 420. Shown in FIG. 28, supply line 746 extends through hollow narrowed-down section 720 and connects gas canister 410 with gas inlet connector 726. Gas flow through supply line 746 is regulated via flow adjustment knob 414 and valve and regulator assembly 412. Igniter wire 744, also passing through hollow narrowed-down section 720, connects button 420 with igniter 724, permitting the operator to activate an electric ignition system and start the catalytic heating process in catalytic heater 418 (as described similarly in other embodiments).

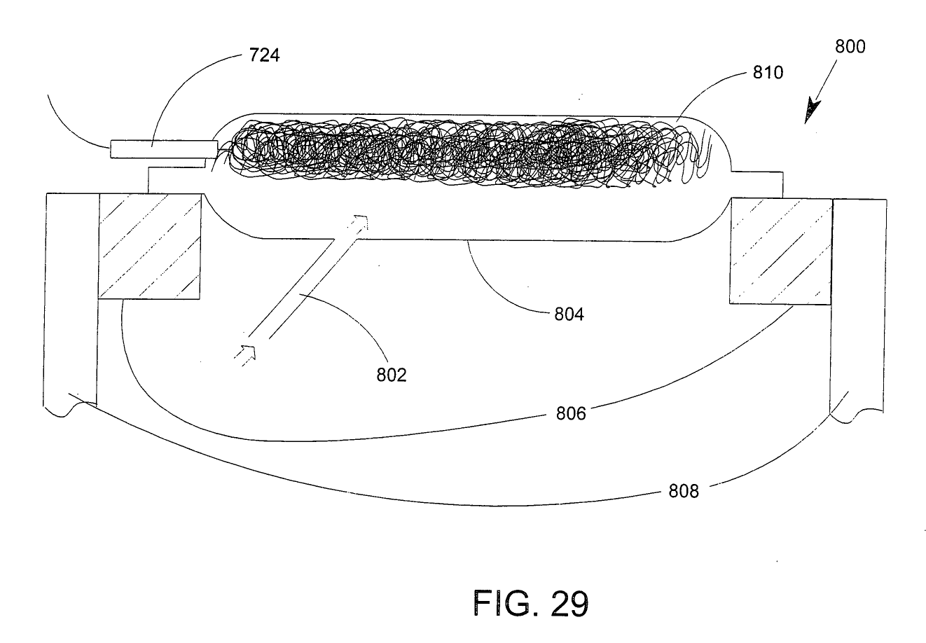

Reference is now made to FIG. 29, which shows diagrammatically an embodiment of the internal structure of catalytic heater 418. This embodiment demonstrates the use of a thermal barrier 806 to reduce the conduction of heat between catalytic material 810 and other elements of the heating system. This material can be chosen from several known within the industry to have thermally insulating properties, including glass ceramics such the machineable ceramic marketed under the tradename Macor®. Burner housing 804 holds and protects catalytic material 810, and includes gas inlet 802 through which fuel for the catalytic process passes. Burner housing 804 is supported by thermal barrier 806, reducing heat transfer between catalytic material 810 and other components within the catalytic heating system. Thermal barrier 806 is supported and connected within the catalytic heater by general metallic structure 808. Igniter 724 interfaces with burner housing 804 and provides the spark to start the catalytic heating process with the electronic ignition system.

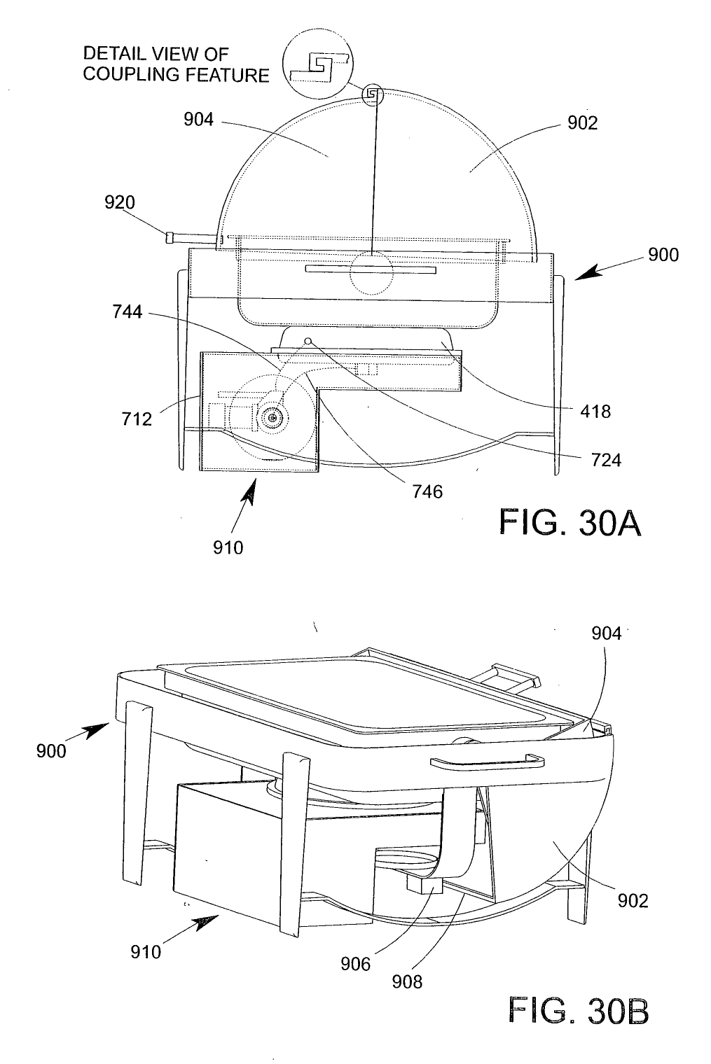

Having described several embodiments of catalytic heating system designs, attention is now drawn to alternative serving dish cover designs adapted to efficiently incorporate non-electric heater systems and/or better protect food from incidental contamination. Reference is now made to FIGS. 30A and 30B, which show diagrammatically an embodiment of a telescoping cover design that allows for catalytic heater and other non-electronic heating systems to be placed substantially beneath a serving tray apparatus. In particular, this embodiment avoids a need for the narrowed-down section 720 of the catalytic heater design of FIGS. 27 and 28 and is suitable for more compact heater designs, such as that designated by 910 in FIG. 30B. Designated at 906, FIG. 30A shows detail and scale views of the coupling mechanism which frictionally links smaller cover segment 904 and larger cover segment 902. Use of moderate pressure with cover handle 920 releases coupling mechanism 906, allowing smaller cover segment 904 to telescope underneath larger cover segment 902 and allow both segments to slide substantially underneath serving tray stand 900. Shown in FIG. 30 fully open, both larger cover segment 902 and smaller cover segment 904 are held stationary at rest via leading edge 908 at stop 906, leaving a significant amount of unobstructed space beneath tray stand 900 for catalytic and other non-electric heating systems (e.g. catalytic heater system design 910 is adapted to slide fully underneath serving tray stand 900 without interfering with movement of cover segments 902 and 904).

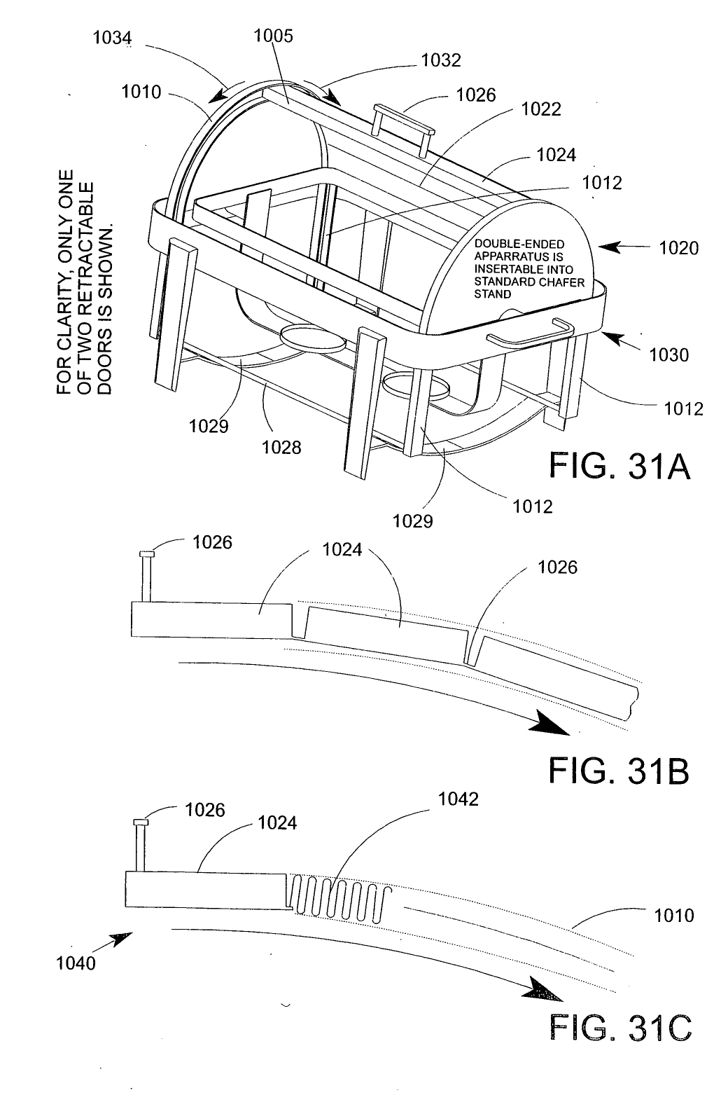

FIG. 31A diagrammatically shows an embodiment of a chafing dish stand with a food cover designated at 1020 that incorporates foldable slats 1024 in cover door 1005. As cover door 1005 opens and slides in path designated at 1032 through channel 1010, slats 1024 fold and stack upon each other at bottoms of upright portions 1012 of channels 1010. Tie rods 1028 connect with upright portions 1012 of channels 1010 for added support and stability and rest on tray stand supports 1029. Now referencing FIG. 31B, slats 1024 are free to hinge with respect to each other via flexure hinges 1026 so that they may move through channels 1010 and fold and stack upon each other within upright portions 1012 of channels 1010. Not shown in FIG. 31A is an identical door opposite to door 1005 which slides down through path 1034 along channels 1010, allowing access to food from both front and back sides of stand 1000. Cover door 1005, channels 1010 and tie rods 1028 together can be alternatively designed as complete separate assemblies so they can be inserted into existing standard chafing tray stands similar to that designated at 1030. This design similarly allows for storage substantially underneath the standard chafing system stand 1030 for non-electric heater systems.

Reference is now made to FIG. 31C, which diagrammatically shows another embodiment of a space-saving serving tray cover design, designated at 1040, which functions within a similar configuration to that of FIGS. 31A and 31B. Cover door design 1040 incorporates strong but flexible material 1042 as an alternative to the slats 1024 of FIGS. 31A and 31B. Flexible material 1042, which can be comprised of fabric such as accordian-folded stainless steel cloth made by TWP, Inc. of California and Belleville Wire Cloth Co. of New Jersey, is attached to a single slat 1024 shown with door handle 1026. As cover door 1040 opens, flexible material 1042 is moved through channels 1010, flexible material 1042 folds accordian-style and, when cover door 1040 is fully opened, flexible material 1042 lays folded in upright portions 1012 of channels 1010 shown in FIG. 31A. This embodiment likewise frees space underneath standard chafing system stand 1030 for non-electric heating systems.

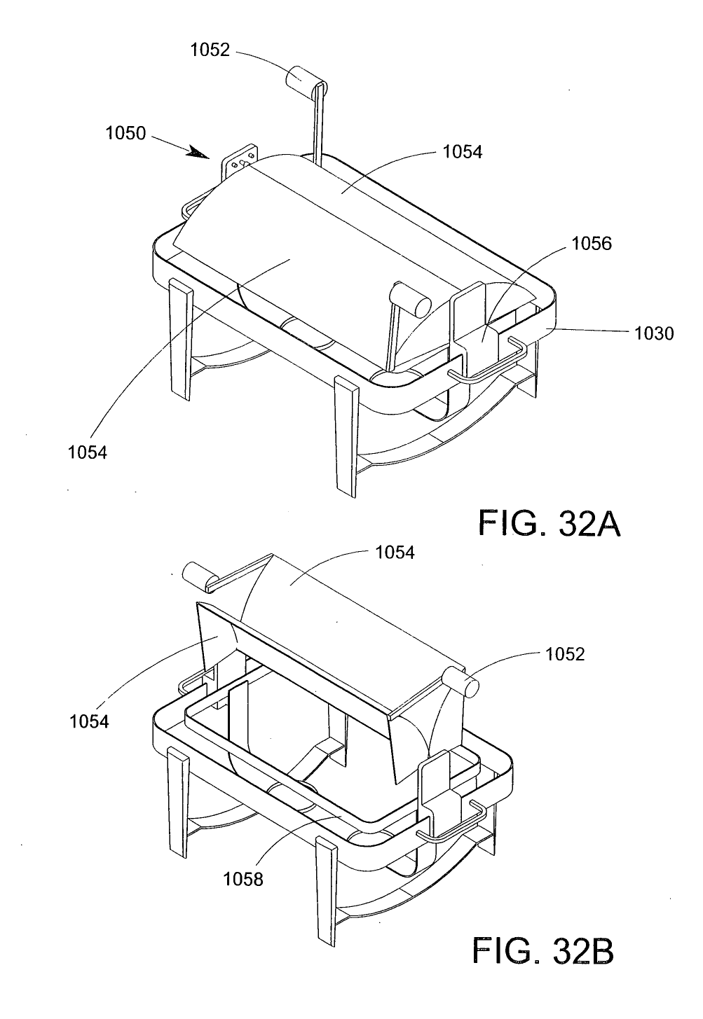

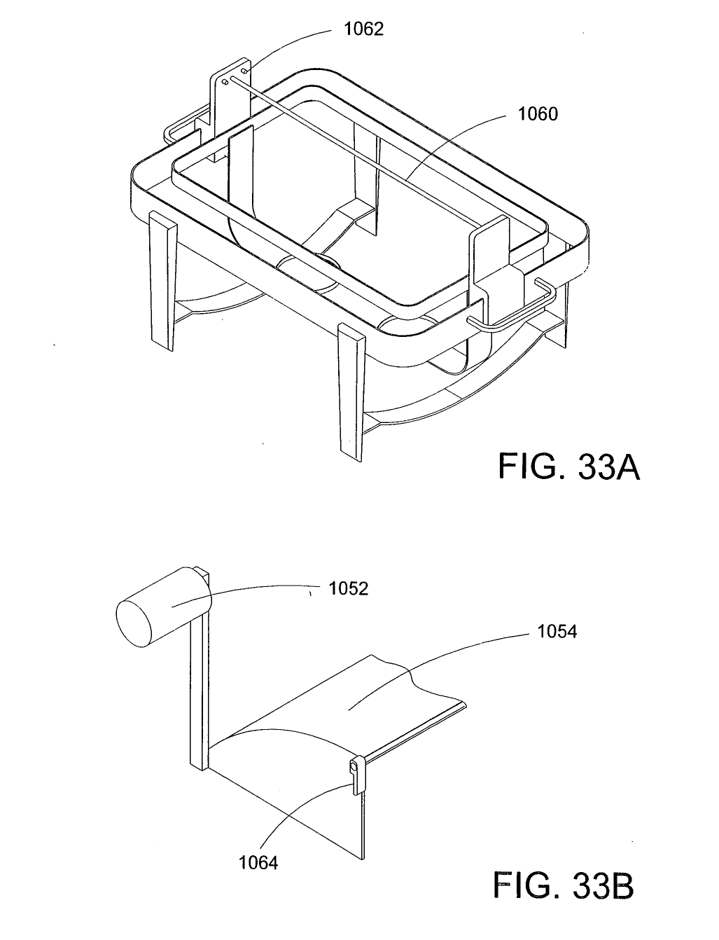

Reference is now made to FIGS. 32A and 32B which diagrammatically shows an embodiment of the food cover design designated at 1050. Domed doors 1054 are pivoted open by applying force to weighted handles 1052. Domed doors 1054, shown in FIG. 33A, are connected to and pivot about shaft 1060. As doors 1054 open, weighted handles 1052 provide sufficient mass such that the center of gravity of doors 1054 shifts across the axis and in the direction of pivoting motion. Thus, when doors 1054 are fully open and in a substantially vertical position, as shown in FIG. 32B, contacts 1064 (shown in FIG. 33B) of doors 1054 rest stationary upon stop pins 1062 (shown in FIG. 33A). Doors 1054 are manually closed by pulling back on weighted handles 1052. Embodiments of food cover design 1050 can alternatively be adapted for existing styles of chafing tray stands (e.g. stand 1030 as shown in FIGS. 32A and 32B), and likewise free space underneath these stands for non-electric heating systems. This embodiment also provides an advantage over the existing “roll-top” designs in that it does not require reaching across the entire food tray for opening and closing a protective cover, thus reducing the possibility of accidentally dropping contaminants in any served food.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. Portable tray apparatus for displaying, serving, and conserving food, said tray apparatus comprising:
means for supporting food so that said food is readily accessible and visible to a person; and
means for directing a circulating stream of thermally controlled air over the food to aid in conserving its state of preparation and keeping it free of insects and other airborne sources of food contaminants.

2. A method for the portable display, serving, and conserving of food, said method comprising the steps of:
supporting food on a portable support so that is readily accessible and visible to a person; and
directing a recirculating stream of thermally controlled air over the food to aid in conserving its initial state of preparation and keeping it free of insects and other airborne sources of food contaminants.

3. The method of claim 2 further including the step of irradiating said stream of thermally controlled air with UV radiation to sterilize said air.

4. Portable apparatus for heating food from standard catering chafing trays comprising:
means for directing heat generated from a catalytic converter to standard catering industry chafing trays.

5. A method for heating food stored within a standard chafing tray comprising the steps of:
placing heat-producing catalytic converter beneath standard industry chafing tray.

6. Portable tray apparatus for displaying, serving, and conserving food, said tray apparatus comprising:
a chafing tray system for receiving and supporting food so that said food is readily accessible and visible to a person, and a means for heating said chafing tray system with a non-electric radiant heat source.

7. The portable tray apparatus of claim 6, wherein said chafing tray system comprises:
a tray for receiving and holding water,
a tray for receiving and holding said food so that said food is positioned above said tray for receiving and holding water, and
a means for releaseably covering said food; and,
wherein said means for heating said chafing tray system is positioned beneath said tray for receiving and holding water so that said water is heated by said means for heating and so that said food is heated by said water.

8. The portable tray apparatus of claim 6 wherein said heating means comprises a catalytic heater.

9. The portable tray apparatus of claim 8 wherein said catalytic heater is fueled by a gas.

10. The portable tray apparatus of claim 9 wherein said gas is selected from the group consisting of butane and propane and mixtures thereof.

11. The portable tray apparatus of claim 10 wherein said gas is contained in a tank within said apparatus.

12. The portable tray apparatus of claim 8 comprising:
means for supporting and thermally isolating said catalytic heater from other elements of said portable tray apparatus.

13. The portable tray apparatus of claim 12 wherein said means for supporting and thermally isolating said catalytic heater comprises a thermally insulating material which connects and supports said catalytic heater so that the transfer of heat from said catalytic heater to connected non-heating elements of said portable tray apparatus is substantially reduced.

14. The portable tray apparatus of claim 13 wherein said thermally insulating material is selected from the group of materials consisting of ceramics.

15. The portable tray apparatus of claim 14 wherein said thermally insulating material is selected from the group of materials consisting of glass ceramics.

16. The portable tray apparatus of claim 6 wherein said apparatus comprises a traditional roll-top mechanism for covering said food.

17. The portable tray apparatus of claim 14 wherein said means for heating comprises a narrowed down section so that said means for heating avoids mechanical interference with motion of said traditional roll-top mechanism.

18. Portable tray apparatus for displaying, serving, and conserving food, said tray apparatus comprising:
a chafing tray apparatus and means for supporting food so that said food is readily accessible and visible to a person;
a means for covering said food comprising arch shaped channels adjacent to the sides of said tray apparatus, and
vertical portions of said channels adjacent to the front and back of said tray apparatus for storing substantially said cover when said covering means is open.

19. The portable tray apparatus of claim 18 wherein said cover is comprised of slats connected together with flexible hinges so that said slats can slide through said channels and so said slats can fold and rest upon each other within said vertical portions of said channels; and,
a means for sliding said cover with said slats within said channels.

20. The portable tray apparatus of claim 18 wherein said cover is comprised of strong flexible material so that said flexible material can slide within said channels and fold upon itself within said vertical portions of said channels; and,
a means for sliding said cover and flexible material within said channels.

21. The portable tray apparatus of claim 20 wherein said strong flexible material is selected from the group of materials consisting of stainless steel cloth.

22. Portable tray apparatus for displaying, serving, and conserving food, said tray apparatus comprising:
a chafing tray for receiving means for supporting food so that said food is readily accessible and visible to a person; and,
a cover for covering means of said food comprising two half-dome shaped doors, a means for pivoting said doors open and closed about an axis substantially centered within said chafing tray with said axis extending substantially along the length of said chafing tray; and,
and a means for holding said doors stationary when said doors are in a substantially vertical position.

23. The portable tray apparatus of claim 22, wherein said means for holding said doors stationary comprises weighted handles so that, as said doors are opened, the center of gravity of said doors will shift across and behind said axis so that when said doors are in said substantially vertical position said doors will be statically stable in said position; and,
a means for stopping said doors from pivoting past said substantially vertical position.
